(19) United States
(12) Patent Application Publication
(10) Pub. No.: US 2014/0154468 A1
(43) Pub. Date: Jun. 5, 2014

(54) COMPOSITE OF SIZE-CONTROLLABLE METAL NANOPARTICALES AND THE METHOD OF MAKING THE SAME

(71) Applicant: NATIONAL TAIWAN UNIVERSITY, TAIPEI (TW)

(72) Inventors: Jiang-Jen Lin, Taipei (TW); Yi-Ting Wang, Taipei (TW); Jiun-Chiou Wei, Taipei (TW); Yu-Ting Yen, Taipei (TW)

(73) Assignee: NATIONAL TAIWAN UNIVERSITY, TAIPEI (TW)

(21) Appl. No.: 13/705,674

(22) Filed: Dec. 5, 2012

(51) Int. Cl. A01N 25/26

(52) U.S. Cl. CPC A01N 25/26
USPC 428/148; 427/180

(57) ABSTRACT

A method of synthesizing size-controllable metal nanoparticles includes the following steps: a) Preparing an exfoliated silicate clay solution and a metal ion solution; and b) Mixing the exfoliated silicate clay solution with the metal ion solution, and the metal ions are reduced to the metal nanoparticles, which are attached to the exfoliated silicate clays. Additionally, in step A, adjust the weight ratio of the silicate clays to the metal ions to control the size of the reduced metal particles. And with larger weight ratio of the silicate clays to the metal ions, the size of the reduced metal particles becomes smaller.

### BACKGROUND OF THE INVENTION

1. Field of the Invention

The present invention relates generally to a method of making a composite of metal particles and exfoliated silicate clay, and more particularly to a method of making a composite which is able to control the size of metal nanoparticles.

2. Description of the Related Art

Silver nanoparticles are well known in antimicrobial activity, and can be used to kill more than 600 species of bacteria. Silver nanoparticles are important nanomaterials applied in many fields, such as biotechnology, medicine, biomedical material, chemistry, chemical engineering, nanocomposite, etc. In synthesis of silver nanoparticles, the silver particles are hard to disperse because of the effect under nanometer scale and the van der Waals force. Therefore, the important target in study of producing silver nanoparticles is to find methods to control their size, stability and dispersion.

The conventional methods of producing the silver nanoparticles are mainly classified into physical and chemical processes. The silver nanoparticles can be directly obtained through the physical process. However, specific equipment is needed in the physical process, such as decomposing a bulk phase material into nanoparticles by high power laser, or vaporizing metal and condensing the vapor to obtain nanoparticles. However, these two physical processes are very complex and need expensive equipments. Furthermore, in operation or the process of producing silver nanoparticles, the concentration of silver ions solution must be in a limited range, usually between several ppm and hundreds ppm. The silver particles will aggregate if the concentration of silver ions solution is too high.

Chemical process is to reduce silver ions into silver atoms in a specified solution. The silver atoms will aggregate after reduction reaction so that stabilizer will be added to stabilize the nanoparticles. The stabilizer will be on the surfaces of the nanoparticles to avoid aggregation. The actions of the stabilizer include:

1) The stabilizer makes the nanoparticles have electric charges on their surface to form electric double layer, so that each nanoparticle carries the same electric charges. Therefore, the nanoparticles will disperse because of the Coulomb force. However, the nanoparticles will aggregate while the electric charges on the surfaces of nanoparticles being replaced by neutral elements. Furthermore, in a high concentration or high ionic strength solution, with the increase of dielectric strength, the electric double layer is compressed, which is bad for stabilizing the nanoparticles.

2) The organic component of the stabilizer forms a protective layer on the nanoparticles to avoid aggregation. It is called “steric stabilization”. The common stabilizer includes water-soluble synthetic polymers (e.g. PVP, PVA, polymethylvinylether, PAA, etc.), dendrimer, sodium citrate, surfactant, ligand, and chelating agent, etc.

Conventional stabilizer is mostly organic polymer. The species and the mixture ratio of the polymers affect the sizes of the silver nanoparticles. However, the composite having the polymers and the silver nanoparticles will aggregate because of heat, and therefore the silver nanoparticles are getting bigger.

The earlier inventions of the present inventors provide exfoliated inorganic clay as the dispersing agent or stabilizer of metal particles to synthesize a composite of metal nanoparticles and exfoliated platelet-shaped clay. The exfoliated platelet-shaped clay is nano silicate platelet which is developed by the present inventors, and the methods of making such nano silicate platelet are taught in Taiwan patents 1280261, 1284138, 1270529, 577904, and 593480. As shown in FIG. 1, sodium montmorillonite 1 enters the clay platelets through the polymer 2 to exfoliate the clay platelets, and then the nano silicate platelet 3 will be obtained after a series of extracting processes. The silicate platelet has many characteristics, including high aspect ratio (average 100×100×1 nm³), high surface area (700-800 m² per gram), and high electric charge (ca. 20,000 ions per piece). An average weight of the silicate platelet is 4×10¹⁶ pieces per gram. These characteristics make the silicate platelet to disperse the silver nanoparticles stably.

The composite of the metal nanoparticles and the exfoliated platelet-shaped clay made by aforesaid method is inorganic. It is different from the conventional organic-inorganic composite in which the silver nanoparticles are reduced and stabilized by the organic polymers. But it is still not easy to make high-dispersed silver nanoparticles, and hard to control the particle's size, and furthermore, the stability of the silver nanoparticles under thermal treatment still has to be improved, therefore the present inventors are working on the study of the composite of the metal nanoparticles and the platelet-shaped clay.

### SUMMARY OF THE INVENTION

The primary objective of the present invention is to provide a method of making a composite of metal nanoparticles, which is able to control the size of metal particles.

The secondary objective of the present invention is to provide a method of making a composite of metal nanoparticles, in which the metal nanoparticles have high stability under thermal treatment and can be re-dissolved in the solution without aggregation.

According to the objective of the present invention, the present invention provides a method of making a composite of size-controllable metal nanoparticles, which includes the steps of a) preparing a solution of exfoliated silicate clay and a solution of metal ions; and b) mixing the solution of the exfoliated silicate clay with the solution of the metal ions to reduce the metal ions to metal nanoparticles and attach the metal nanoparticles to the exfoliated silicate clay.

The method further comprise the step of adjusting a weight ratio of the metal ion to the exfoliated silicate clay in the step a), whereby the size of the metal nanoparticles in the step b) is reducing while the weight ratio of the metal ion to the exfoliated silicate clay is increasing.

In an embodiment, the metal nanoparticles may be silver, copper, iron, or gold, and silver is preferable.

In an embodiment, the exfoliated silicate clay is made by an exfoliated platelet-shaped clay, and the clay is selected from the group consisting of bentonite, Li-based bentonite, montmorillonite, artificial mica, kaolinite, talc, attapulgite, vermiculite, and smectic hydroxide, and nanoscale silicate platelets of exfoliated montmorillonite is preferable.

In an embodiment, the solution of metal ion is selected from the group consisting of nitrate solution, chloride solution, and bromated solution of the selected metal ion. For example, if the metal ion is silver ion, then the preferred solution is selected among silver nitrate solution, silver chloride solution, and silver bromated solution.

In an embodiment, the composite is made into a film, and the film is reversible to be re-dissolved in the solution. The change of diameters of metal nanoparticles before and after re-dissolving is less than 7%.

In an embodiment, the weight ratio of the metal ion to the exfoliated silicate clay is in a range between 0.5/99.5 and 50/50.

Therefore, it provides a method of making composite of size-controllable metal nanoparticles, which has the ability to disperse and stabilize the metal nanoparticles, and it may control the diameter of the metal nanoparticles by adjusting the weight ratio of the metal ion to the exfoliated silicate clay.

### BRIEF DESCRIPTION OF THE DRAWINGS

FIG. 1 is a sketch diagram, showing fabrication of the nano silicate platelets and stable production of the silver nanoparticles;

FIG. 2 is a spectrogram of the solution of AgNP/NSP (7/93) which is reduced by ethanol;

FIG. 3 is a spectrogram of the solution of AgNP/MMT (7/93) which is reduced by ethanol;

FIG. 4 is a spectrogram of the solution of AgNP/NSP (7/93) which is reduced by methanol;

FIG. 5 is a spectrogram of the solution of AgNP/NSP (7/93) which is reduced by isopropanol;

FIG. 6(a) to FIG. 6(d) are pictures taken via TEM, showing the distribution of the particle's size of (a) AgNP/NSP reduced by ethanol; (b) AgNP/MMT reduced by ethanol; (c) AgNP/NSP reduced by methanol; and (d) AgNP/NSP reduced by isopropanol;

FIG. 7 are pictures taken via TEM, showing the size change because of the thermal treatment, in which (a) and (d) are Ag/SMA3000-M2070, (b) and (e) are Ag/MMT, and (c) and (f) are Ag/NSP; (a)-(c) show the particle's size before the thermal treatment, and (d)-(f) show the particle's size after accepting thermal treatment for 8 hours;

FIG. 8 is a spectrogram of (a) UV absorbance of AgNP/NSP solution; and (b) UV absorption of AgNP/MMT solution;

FIG. 9(a) to FIG. 9(f) are pictures taken via TEM, showing the mean diameter of AgNP/NSP in (a) 0.5/99.5 wt % (P3.6), (b) 1/99 wt % (P3.8), (c) 7/93 wt % (P5), (d) 15/85 wt % (P9), (e) 30/70 wt % (P17), and (f) 50/50 wt % (P35);

FIG. 10(a) to FIG. 10(e) are pictures taken via TEM, showing the mean diameter of AgNP in EtOH/H₂O in different weight ratios (a) 1/1, (b) 3/1, (c) 5/1, (d) 10/1, and (e) 1/0;

FIG. 11 is a diagram of the mean diameter of AgNP with different contents of ethanol;

FIG. 12 is a spectrogram of the UV absorbance of AgNP in (a) solution, (b) film, and (c) re-solution;

FIG. 13 is a spectrogram of the AgNP in solution, film, and re-solution;

FIG. 14 are pictures taken via TEM, showing the diameter of AgNP in (a) solution, and (b) re-solution (Ag-NSP(7/93)/PVA=10/90);

FIG. 15 shows the antimicrobial effect of AgNP/clay (AgNP: 10 ppm) on E. coli;

FIG. 16 shows the antimicrobial effect of AgNP/NSP on Gram-negative bacteria and Gram-positive bacteria (a) E. coli (AgNP: 10 ppm), (b) Pseudomonas aeruginosa (AgNP: 20 ppm), (c) Staphylococcus aureus (AgNP: 30 ppm), and (d) Streptococcus pyogenes (AgNP: 10 ppm); wherein the control group is NSP;

FIG. 17 are FE-SEM pictures of E. coli cultured on AgNP/NSP;

FIG. 18 are FE-SEM pictures of Staphylococcus aureus cultured on AgNP/NSP; and

FIG. 19 shows the antimicrobial effect of AgNP/NSP, wherein AgNP having similar size but different weight ratio, on E. coli, and the control group is 0.1 wt % NSP.

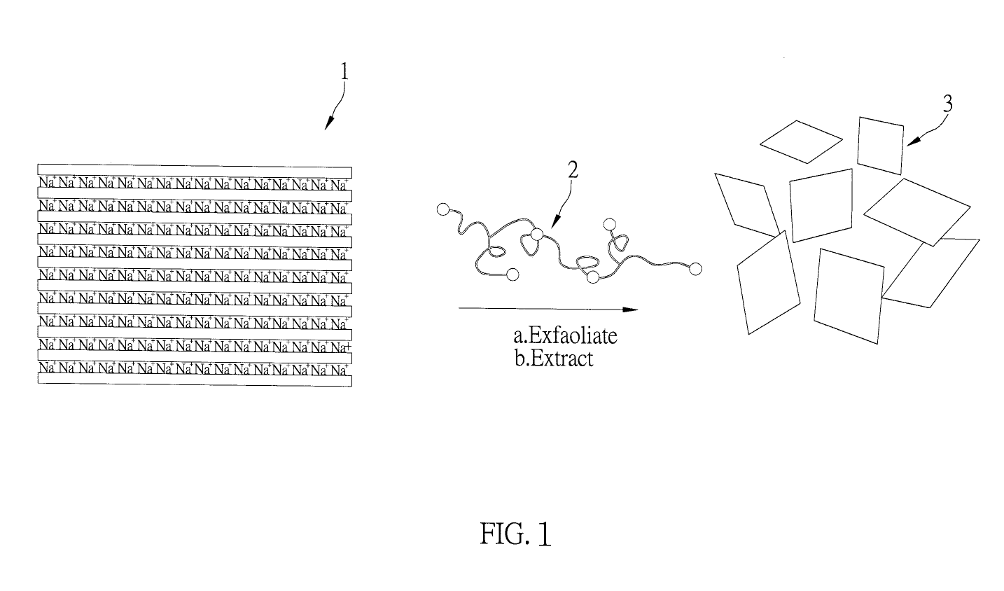

### DETAILED DESCRIPTION OF THE INVENTION

The materials and bacteria used in the present invention include:

1. Nanoscale silicate platelets (NSP), which is made of exfoliated sodium montmorillonite, and the detail process can be found in Taiwan patents 1280261, 1284138, 1270529, 577904, and 593480.

2. Sodium montmorillonite (Na+-MMT), which is smectic aluminium silicate clay, purchased from Nancor Co.

3. Silver nitrate (AgNO₃, Mw.=169.87 g/mol) purchased from J.T. Baker, Inc.

4. Methanol (MeOH, 95%), which is a weak reducing agent to slowly reduce silver ion to silver nanoparticle in 30° C.-150° C.

5. Ethanol (EtOH, 99.5%), which is a weak reducing agent to slowly reduce silver ion to silver nanoparticle in 30° C.-150° C.

6. Isopropyl alcohol (C₃H₈O, 95%), which is a weak reducing agent to slowly reduce silver ion to silver nanoparticle in 30° C.-150° C.

7. Sodium borohydride (NaBH₄), which is a strong reducing agent to rapidly reduce silver ion.

8. SMA (SMA3000-M2070), referring to Macromolecules 2007, 40, 1579-1584 for detail.

9. poly(vinyl alcohol) (PVA, Mw.=74800g/mo, hydrolysis=98.5−99.2 mol %) purchased from Chang Chun Petrochemical Co.

10. Bacteria strains: Staphylococcus aureus 71 ; 431 ; 10781, Streptococcus pyogenes Rob 193-2, Pseudomonas aeruginosa, and E. coli provided by Dr. Su, Hong-Lin who is a professor of department of life sciences of National Chung Hsing University.

11. Standard bacteria solution, which is made by adding overnight bacteria solution into fresh Luria-Bertani (LB) in a volume ratio of 1/100 for three hours, and choose the bacteria solution with OD600 in a range between 0.4 and 0.6.

The detailed description and technical contents of the present invention will be explained with reference to the accompanying drawings. However, the drawings are illustrative only but not used to limit the present invention.

We take the synthesis of silver nanoparticles (AgNP)/nanoscale silicate platelets (NSP) for example to explain the metal particles/exfoliated silicate clay of the preferred embodiment of the present invention. It is easy to understand that it may use different exfoliated platelet shaped clay as carrier, such as bentonite, Li-based bentonite, montmorillonite, artificial mica, kaolinite, talc, attapulgite, vermiculite and smectic hydroxide, etc.

The metal ion in the present embodiment may be silver ion, gold ion, copper ion, iron ion, and other suitable ions. The silver ion may be obtained from silver nitrate, silver bromide, silver chloride, silver bromated, silver chlorate, and any suitable solution.

In an embodiment of the present invention, the synthesis of silver nanoparticles (AgNP)/nanoscale silicate platelets (NSP) includes the following three parts:

1) Reduce the silver ions by ethanol and stabilize the dispersed AgNP by the NSP;

2) Adjust the weight ratio of the silver ions (Ag ⁺) to the NSP to control the size of the AgNP; and

3) Adjust the weight ratio of ethanol to water to control the size of the AgNP.

### EXAMPLE 1

### Reduce A_{g}⁺ by Ethanol and Stabilize the Dispersed AgNP by the NSP.

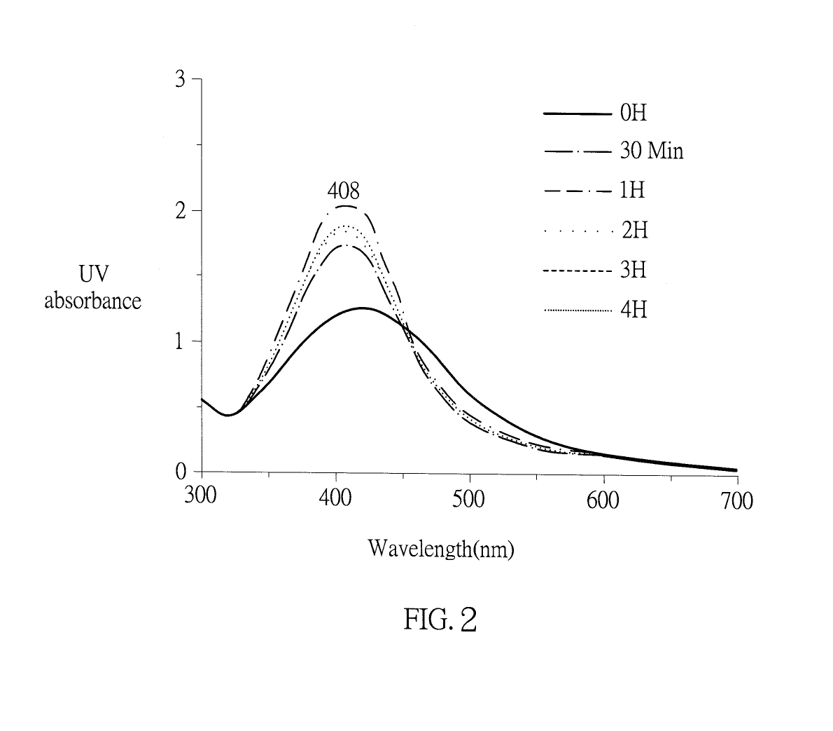

The weight ratio of Ag⁺ to NSP is 7/93. First, prepare the NSP solution (46.5 g, 2wt % in water) and the AgNO₃ solution (0.11 g, 1 wt %), and then pour the NSP solution(2 wt %) and ethanol (49.5 g) into a 250 mL three-neck round-bottom flask to obtain a 1 wt % solution. Next, stir the solution by a magnet for half an hour, and provide nitrogen to prevent generation of silver oxidant. A cooling device is provided to prevent evaporation of ethanol. Next, slowly drop the AgNO₃ solution into the solution, and keep stirring for half an hour until the color of the solution changing to milky white. A reduction-oxidation reaction will occur in the solution while the temperature rises to 80° C., and the color of the solution changes to yellowish-brown three hours later. An UV spectrometer is used here to monitor the growth of the silver nanoparticles (the characteristic absorbance wavelength is 408 nm). It tells that the reaction is completed when the absorbance strength keeps still. Next, filter out of the un-reacted ethanol by suction filtration (using No. 5 filter paper of whatman®, Cat. No. 1005 090), and scratch the residual material off the filter paper, and then dissolve the residual material in the water to form a re-solution (3 wt %). The color of the re-solution in 100 ppm is golden. FIG. 2 shows the UV absorbance spectrogram of the reduced silver ions, in which the characteristic absorbance peak of the nanoparticles is 408 nm, which proves the existence of the silver nanoparticles.

### EXAMPLES 2-6

### Adjust the Weight Ratio of the Silver Ions (Ag⁺) to Nanoscale Silicate Platelets (NSP) to Control the Size of Silver Nanoparticle (AgNP)

In these examples we apply the same test as EXAMPLE 1 and control the weight ratios of the silver ions (Ag⁺) to nanoscale silicate platelets (NSP). The weight ratios are shown in Table 1.

### EXAMPLE 2

### Weight Ratio of Ag⁺/NSP is 0.5/99.5

First, prepare the NSP solution (9.95 g, 10 wt % in water) and the AgNO₃ solution (0.79 g, 1 wt % in water), and then pour the NSP solution, water (39.76 g) and ethanol (49.5 g) into a 250 mL three-neck round-bottom flask to obtain a 1 wt % solution. The weight ratio of water to ethanol in the solution is 1/1. Next, stir the solution with a magnet for half an hour. The following steps are the same as EXAMPLE 1.

### EXAMPLE 3

### Weight Ratio of Ag⁺/NSP is 1/99

First, prepare the NSP solution (9.9g, 10 wt % in water) and the AgNO₃ solution (1.57 g, 1 wt % in water), and then pour the NSP solution, water (39.04 g) and ethanol (49.5 g) into a 250 mL three-neck round-bottom flask to obtain a 1 wt % solution. A weight ratio of water to ethanol in the solution is 1/1. Next, stir the solution with a magnet for half an hour. The following steps are the same as EXAMPLE 1.

### EXAMPLE 4

### Weight Ratio of Ag⁺/NSP is 15/85

First, prepare the NSP solution (8.5 g, 10 wt % in water) and the AgNO₃ solution (23.62 g, 1 wt % in water), and then pour the NSP solution, water (18.47 g) and ethanol (49.5 g) into a 250 mL three-neck round-bottom flask to obtain a 1 wt % solution. A weight ratio of water to ethanol in the solution is 1/1. Next, stir the solution with a magnet for half an hour. The following steps are the same as EXAMPLE 1.

### EXAMPLE 5

### Weight Ratio of Ag⁺/NSP is 30/70

First, prepare the NSP solution (7.0 g, 10 wt % in water) and the AgNO₃ solution (23.62 g, 2 wt % in water), and then pour the NSP solution, water (20.05 g) and ethanol (49.5 g) into a 250 mL three-neck round-bottom flask to obtain a 1 wt % solution. A weight ratio of water to ethanol in the solution is 1/1. Next, stir the solution with a magnet for half an hour. The following steps are the same as EXAMPLE 1.

### EXAMPLE 6

### Weight Ratio of Ag⁺/NSP is 50/50

First, prepare the NSP solution (5.0g, 10 wt % in water) and the AgNO₃ solution (39.37 g, 2 wt % in water), and then pour the NSP solution, water (6.42 g) and ethanol (49.5 g) into a 250 mL three-neck round-bottom flask to obtain a 1 wt % solution. A weight ratio of water to ethanol in the solution is 1/1. Next, stir the solution with a magnet for half an hour. The following steps are the same as EXAMPLE 1.

### EXAMPLES 7-10

### Adjust a Weight Ratio of Deionized (DI) Water to Ethanol to Control the Size of Silver Nanoparticle (AgNP):

A constant weight ratio of Ag⁺/NSP is 1/99, and the weight ratios of DI water/ethanol are shown in the Table 1.

### EXAMPLE 7

### Weight Ratio of DI Water/Ethanol=3/1

A weight ratio of Ag⁺/NSP is 1/99: First, prepare NSP solution (9.9 g, 10 wt % in water) and the AgNO₃ solution (1.57 g, 1 wt % in water), and then pour the NSP solution, water (63.79 g) and ethanol (24.75 g) into a 250 mL three-neck round-bottom flask to obtain a 1 wt % solution. A weight ratio of water to ethanol in the solution is 3/1. Next, stir the solution with a magnet for half an hour. The following steps are the same as EXAMPLE 1.

### EXAMPLE 8

### Weight Ratio of DI Water/Ethanol is 5/1

A weight ratio of Ag⁺/NSP is 1/99: First, prepare the NSP solution (9.9 g, 10 wt % in water) and the AgNO₃ solution (1.57 g, 1 wt % in water), and then pour the NSP solution, water (72.04 g) and ethanol (16.5 g) into a 250 mL three-neck round-bottom flask to obtain a 1 wt % solution. A weight ratio of water to ethanol in the solution is 5/1. Next, stir the solution with a magnet for half an hour. The following steps are the same as EXAMPLE 1.

### EXAMPLE 9

### Weight Ratio DI Water/Ethanol is 10/1

A weight ratio of Ag⁺/NSP is 1/99: First, prepare the NSP solution (9.9 g, 10 wt % in water) and the AgNO₃ solution (1.57 g, 1 wt % in water), and then pour the NSP solution, water (79.54 g) and ethanol (9 g) into a 250 mL three-neck round-bottom flask to obtain a 1 wt % solution. A weight ratio of water to ethanol in the solution is 10/1. Next, stir the solution with a magnet for half an hour. The following steps are the same as EXAMPLE 1.

### EXAMPLE 10

### Weight Ratio of DI Water/Ethanol is 1/0

A weight ratio of Ag⁺/NSP is 1/99: First, prepare the NSP solution (9.9 g, 10 wt % in water) and the AgNO₃ solution (1.57 g, 1 wt % in water), and then pour the NSP solution and water (88.54 g) into a 250 mL three-neck round-bottom flask to obtain a 1 wt % solution. A weight ratio of water to ethanol in the solution is 1/0. Next, stir the solution with a magnet for half an hour. The following steps are the same as EXAMPLE 1.

The preferred compared examples of the synthesis of AgNP/NSP include the following three parts:

1) Reduce silver ions (Ag⁺) by ethanol, and stabilize the dispersed AgNP by montmorillonite (MMT);

2) Reduce silver ions (Ag⁺) by different solutions, which are reducing agents also, and stabilize the dispersed AgNP by nanoscale silicate platelets (NSP); and

3) Reduce silver ions (Ag⁺) by NaBH₄ and stabilize the dispersed AgNP by polymer.

### Compared Example 1

### Reduce Ag⁺by Ethanol and Stabilize the Dispersed AgNP by MMT

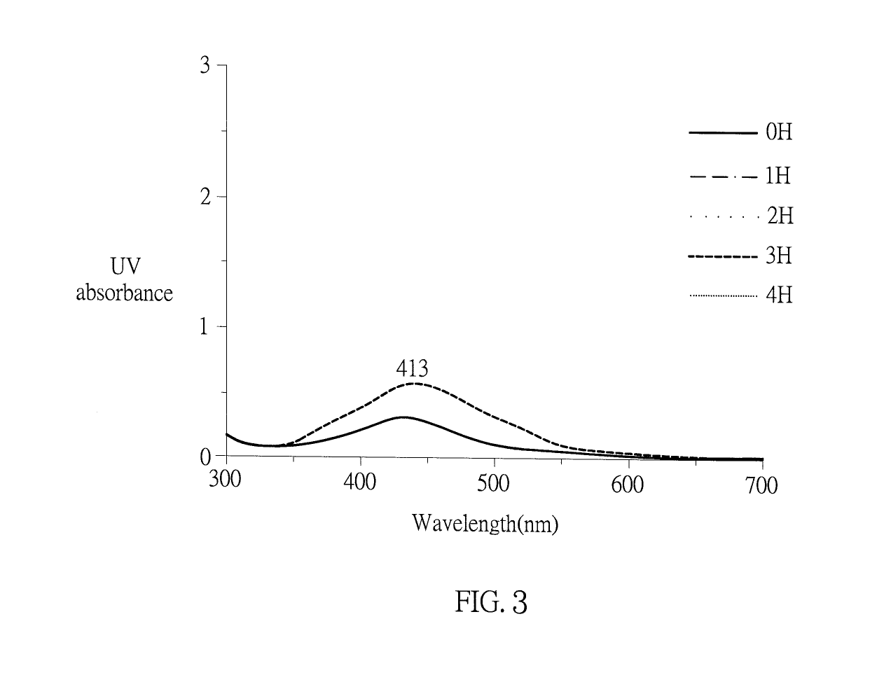

A weight ratio of Ag⁺/MMT is 7/93: First, swell MMT powder with DI water to obtain a MMT solution (18.6 g, 5 wt % in water), and prepare AgNO₃ solution (11.02 g, 1 wt % in water), and then pour the MMT solution, water (20.92 g) and ethanol (49.5 g) into a 250 mL three-neck round-bottom flask to obtain a 1 wt % solution. A weight ratio of water to ethanol in the solution is 1/1. Next, stir the solution with a magnet for half an hour. The following steps are the same as EXAMPLE 1. FIG. 3 shows a UV spectrogram of the solution, in which the characteristic absorbance peak of AgNP is 413 nm after three hours. It is an evidence of the existence of AgNP.

### Compared examples 2-3

### Reduce Silver Ions (A_{g}+) by Different Solutions, Which are Reducing Agent Also, and Stabilize the Dispersed AgNP by Nanoscale Silicate Platelets (NSP)

Methanol (MeOH) and isopropyl alcohol are selected to be a solvent to reduce Ag⁺.

### Compared Example 2

### Methanol Solvent

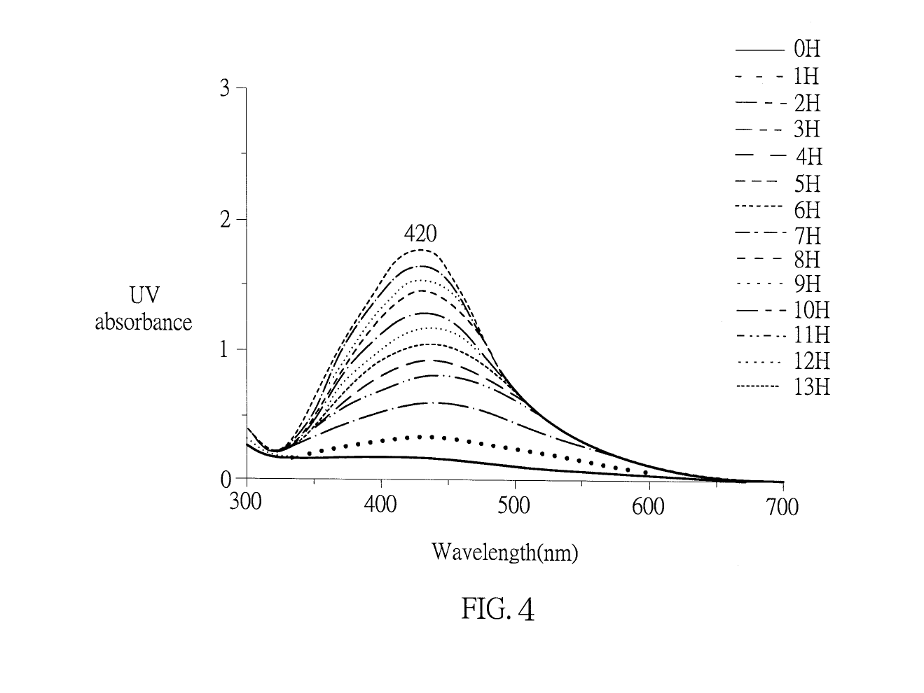

A weight ratio of Ag⁺/NSP is 7/93: First, prepare NSP solution (9.3 g, 10 wt % in water) and AgNO₃ solution (11.02 g, 1 wt % in water), and then pour the MMT solution, water (30.22 g) and methanol (49.5 g) into a 250 mL three-neck round-bottom flask to obtain a 1 wt % solution. A weight ratio of water to methanol in the solution is 1/1. Next, stir the solution with a magnet for half an hour, and provide nitrogen to prevent generation of silver oxidant. A cooling device is provided to prevent evaporation of methanol. Next, slowly drop the AgNO₃ solution into the solution, and keep stirring for half an hour until the color of the solution changing to milky white. A reduction-oxidation reaction is occurred in the solution while the temperature rises to 60° C., and the color of the solution will change to deep yellowish-brown three hours later. An UV spectrometer is used here to monitor the growth of the silver nanoparticles (the characteristic absorbance wavelength is 420 nm). It tells that the reaction is completed when the absorbance strength keeps still. Next, filter out of the un-reacted methanol by suction filtration (using No. 5 filter paper of whatman®, Cat. No. 1005 090), and scratch the residual material off the filter paper, and dissolve the residual material in the water to form a re-solution (3 wt %). The color of the re-solution in 100 ppm is golden. FIG. 4 shows the UV absorbance spectrogram of the reduced silver ions, in which the characteristic absorbance peak of the nanoparticles is 420 nm after accepting twelve hours of reaction, which proves the existence of the AgNP.

### Compared Example 3

### Isopropyl Alcohol Solvent

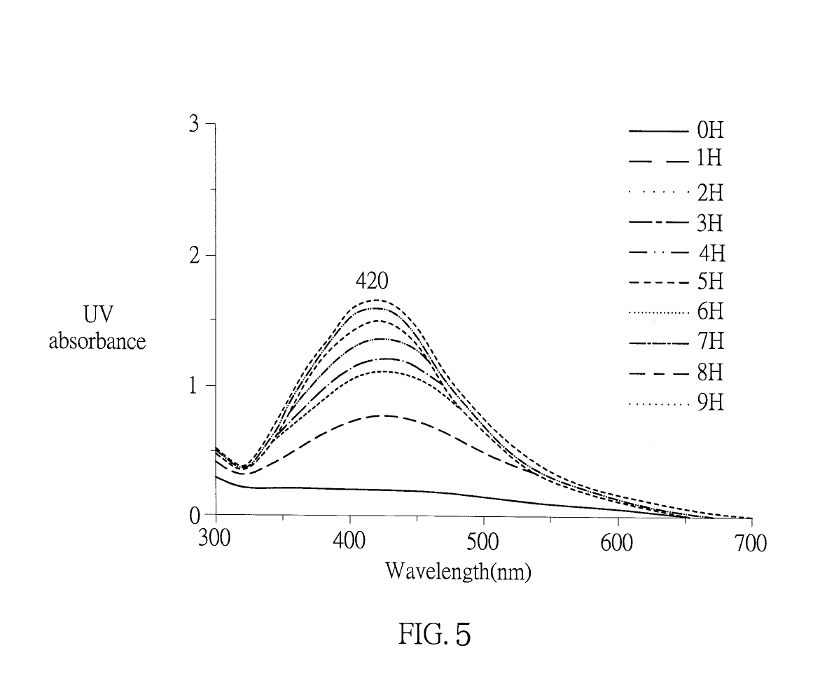

A weight ratio of Ag⁺/NSP is 7/93: First, prepare NSP solution (9.3 g, 10 wt % in water) and AgNO₃ solution (11.02 g, 1 wt % in water), and then pour the NSP solution, water (30.22 g) and isopropyl alcohol (49.5 g) into a 250 mL three-neck round-bottom flask to obtain a 1 wt % solution. A weight ratio of water to isopropyl alcohol in the solution is 1/1. Next, stir the solution with a magnet for half an hour, and provide nitrogen to prevent generation of silver oxidant. A cooling device is provided to prevent evaporation of isopropyl alcohol. Next, slowly drop the AgNO₃ solution into the solution, and keep stirring for half an hour until the color of the solution changing to milky white. A reduction-oxidation reaction is occurred in the solution while the temperature rises to 80° C., and the color of the solution changes to deep yellowish-brown two hours later. An UV spectrometer is used here to monitor the growth of the silver nanoparticles (the characteristic absorbance wavelength is 420 nm). It tells that the reaction is completed when the absorbance strength keeps still. Next, filter out of the un-reacted isopropyl alcohol by suction filtration (using No. 5 filter paper of whatman®, Cat. No. 1005 090), and scratch the residual material off the filter paper, and dissolve the residual material in the water to form a re-solution (3 wt %). The color of the re-solution in 100 ppm is golden. FIG. 5 shows the UV absorbance spectrogram of the reduced silver ions, in which the characteristic absorbance peak of the nanoparticles is 420 nm after accepting eight hours of reaction, which proves the existence of the AgNP.

### Compared example 4

### Reduce Silver Ions (A_{g}+) by NaBH₄ and Stabilize the Dispersed AgNP by Polymer

NSP is replaced by polymeric dispersant (SMA) to disperse AgNP.

### Compared Example 4

### Polymeric Dispersant (SMA)

A weight ratio of Ag⁺/SMA is 7/93: First, respectively dissolve SMA3000-M2070 (0.93 g) and AgNO₃ (0.11 g) in DI water (25 g), and then pour the SMA solution and the AgNO₃ solution into a 250 mL three-neck round-bottom flask, and then stir the solution with a magnet for half an hour and provide nitrogen to prevent generation of silver oxidant. Next, dissolve 0.03 g NaBH₄ in DI water (50 g) to obtain a NaBH₄ solution. Drop the NaBH₄ solution slowly into the solution of SMA and AgNO₃ to obtain a 1 wt % solution. A reduction-oxidation reaction is occurred in the solution, and the color of the solution changes to deep yellowish-brown three hours later. An UV spectrometer is used here to monitor the growth of the silver nanoparticles (the characteristic absorbance wavelength is 390 nm). It tells that the reaction is completed when the absorbance strength keeps still (about 3 or 4 hours), and a 1 wt % AgNP/SMA solution is obtained. The color of the solution in 100 ppm is golden.

TABLE 1
Color of AgNP/NSP solution and UV-visible spectrometer

| | | | | | UV |
|---|---|---|---|---|---|
| | | DI water/ | Reducing | | wavelength |
| | Ag⁺/dispersant^{a} | reducing agent | agent | Color | (nm) |
| | Ag⁺/NSP | | | | |
| EXP. 1 | 7/93 | 1/1 | ethanol | yellowish-brown | 408 |
| EXP. 2 | 0.5/99.5 | | | light brown | 408 |
| EXP. 3 | 1/99 | | | brown | 408 |
| EXP. 4 | 15/85 | | | deep | 409 |
| | | | | yellowish-brown | |
| EXP. 5 | 30/70 | | | deep | 413 |
| | | | | yellowish-brown | |
| EXP. 6 | 50/50 | | | deep | 416 |
| | | | | yellowish-brown | |
| EXP. 7 | 1/99 | 3/1 | | brown | 406 |
| EXP. 8 | 1/99 | 5/1 | | brown | 412 |
| EXP. 9 | 1/99 | 10/1 | | brown | 413 |
| EXP. 10 | 1/99 | 1/0 | | brown | 414 |
| | Ag⁺/MMT | | | | |
| CEXP. 1 | 7/93 | 1/1 | ethanol | yellowish-brown | 413 |
| | Ag⁺/NSP | | | | |
| CEXP. 2 | 7/93 | 1/1 | methanol | yellowish-brown | 420 |
| CEXP. 3 | 7/93 | 1/1 | isopropyl | yellowish-brown | 420 |
| | | | alcohol | | |
| | Ag⁺/polymer | solvent | | | |
| | Ag⁺/SMA | | | | |
| CEXP. 4 | 7/93 | DI water | sodium | deep brown | 413 |
| | | | borohydride | | |

^{a}AgNO₃ is added into silicate platelet solution (NSP: nanoscale silicate platelets; MMT: montmorillonite) or polymer solution (SMA: SMA3000-M2070); weight ratios of Ag⁺/NSP are 0.5/99.5, 1/99, 7/93, 15/85, 30/70, and 50/50.

The above examples disclose the materials and the methods of the present invention. Hereunder we will discuss the thermal stabilization of AgNP. The test of the thermal stabilization includes the following three parts:

1) Exposure Under the UV Spectrometer:

The sample (0.05 wt %) is put under a UV lamp (UVGL-58 Handheld UV lamp, 254/365 nm, 6-Watt, 115 V - 60 Hz, 0.12 Amps) for four hours, and then check the redshift of the absorbance peak by a UV-visible spectrometer (Hitachi U-4100).

2) Thermal treatment:

The sample (1 wt %) is put in 80° C. oil for eight hours, and then check the redshift of the absorbance peak with a UV-visible spectrometer (Hitachi U-4100) and observe the aggregation of particles with a transmission electron microscopy (TEM) (JOEL JEM-1230 electron microscope operating at 100 kV and with a Gatan DualVision CCD Camera).

3) Stability (Reversibility) of the Film:

a) Pure Inorganic Film-Ag/NSP and Ag/MMT Film:

The sample (1 wt %) is dropped on a microscope slide, and then cured in a 60° C. oven. The film on the microscope slide is tested for its absorbance by a UV spectrometer, and then dissolved with DI water. Next, a UV-visible spectrometer (Hitachi U-4100) is used to check the change of the absorbance peak.

b) Inorganic/Organic Film-Ag/NSP/PVA Film

The sample (1 wt %) is mixed with 1 wt % PVA, and then dropped evenly on a Petri dish and baked in a 60° C. oven to obtain a film. The film is tested by the UV spectrometer for its absorbance. Next, dissolve the film by DI water, and use a UV-visible spectrometer (Hitachi U-4100) to check the change of the absorbance peak.

Test 1 and test 2 are applied in EXAMPLE 1, compared example 1, and comparison example 4; test 3-a is applied in EXAMPLE 1 and compared example 1; and test 3-b is applied in EXAMPLE 1, EXAMPLE 3, EXAMPLE 4, EXAMPLE 5, and EXAMPLE 6.

The test of the antimicrobial performance of the silver nanoparticles of the present invention is hereunder:

AgNP/inorganic clay solutions with various concentrations are made in 10 ml Lysogeny broths, and then 100λ standard bacteria solution 1×10⁵ CFU/ml is added. The bacteria is cultured with 37° C. for 3 hours and 24 hours, and then the solution is diluted to suitable concentration. Next, 50λ diluted solution is coated on 10 ml Lysogeny broth by a sterile glass ball. After 24 hours (temperature is 37° C.), the bacterial count is obtained.

There are three different samples:

1) Comparison of antimicrobial performance of AgNP with different stabilizers: AgNP/NSP vs. AgNP/MMT.

2) Comparison of antimicrobial performance under different particle sizes: Four bacteria strains are under comparison, including E. coli, Pseudomonas aeruginosa, Staphylococcus aureus, and Streptococcus pyogenes Rob. And five AgNP/NSP samples are selected with a ratio from 1/99 to 50/50.

3) Comparison of antimicrobial performance under different concentrations: Ratios of AgNP/NSP are 0.5/99.5 vs. 1/99.

The first sample is applied in example 1 and compared example 1; the second sample is applied in EXAMPLE 1, EXAMPLE 3, EXAMPLE 4, and EXAMPLE 5; and the third sample is applied in EXAMPLE 2 and EXAMPLE 3.

The result and analysis of the experiments are:

1) Selection of the Reducing Agent and the Stabilizer:

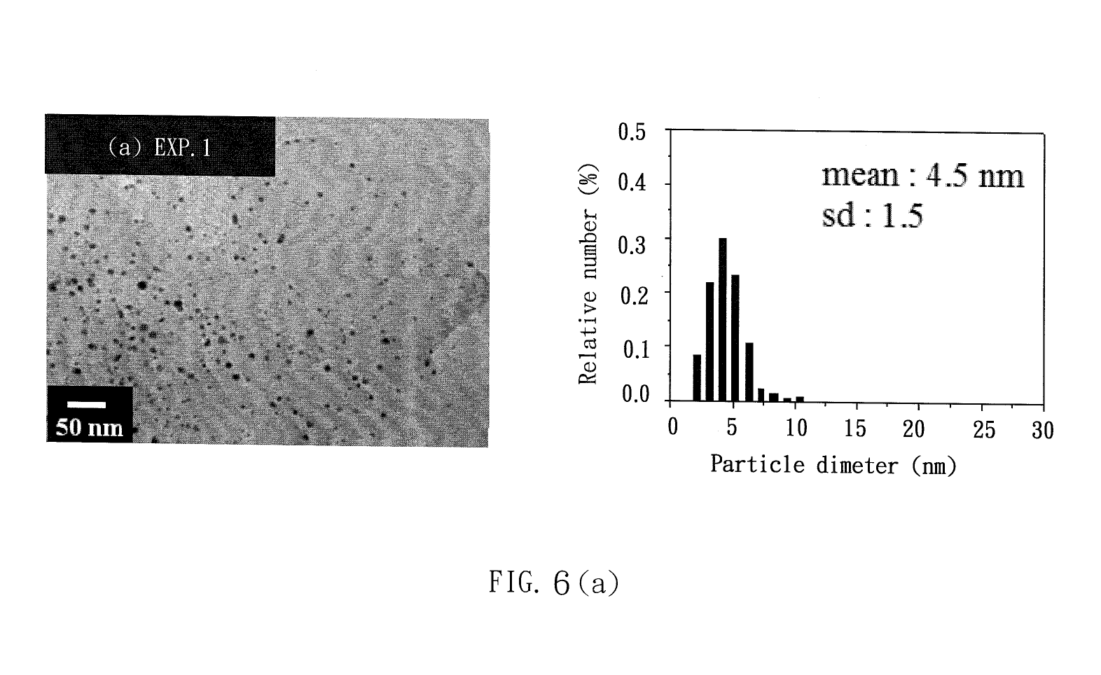

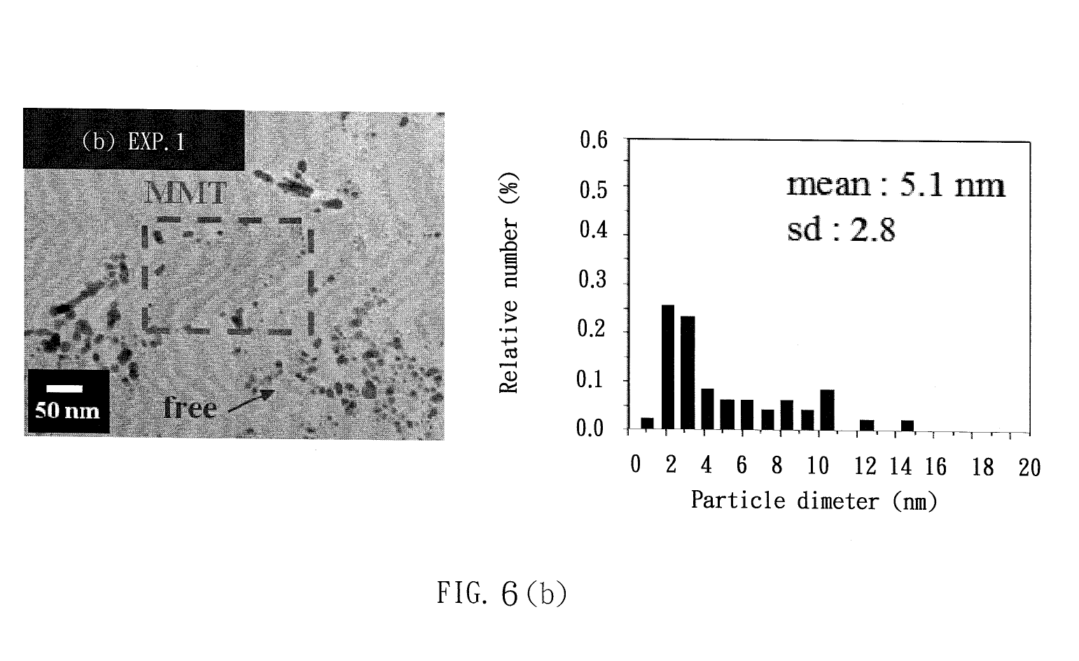

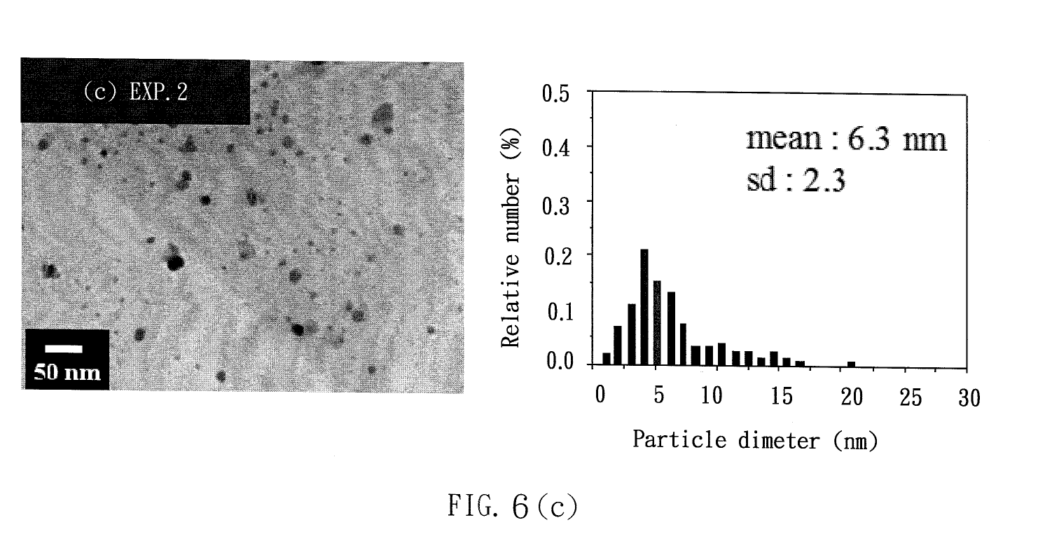

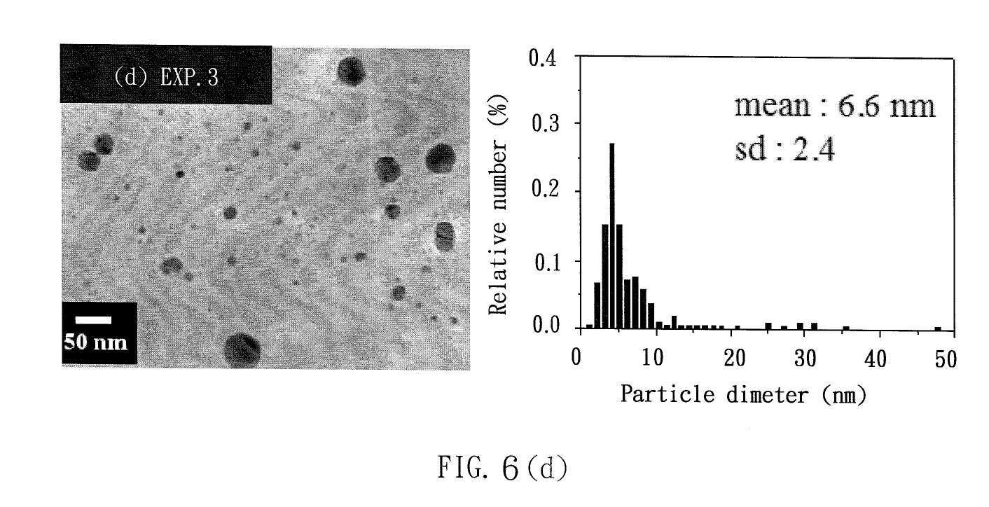

According to the TEM analysis of example 1 and compared examples 1-3, the distribution of particle sizes of AgNP which is reduced by ethanol (FIG. 6(a)) is more uniform than the AgNP reduced by methanol (FIG. 6(c)) and isopropyl alcohol (FIG. 6(d)). The dispersion of the AgNP by NSP (FIG. 6(a)) is better than by MMT (FIG. 6(b)). There are fewer AgNP on the MMT so that AgNP aggregate around MMT. Therefore, methanol and NSP are the preferred stabilizer and reducing agent for AgNP.

2) Stabilization of Dispersion of the AgNP by NSP:

Using NSP to stabilize the dispersion of the AgNP could obtain high stabilization. The particles will not aggregate under UV light and thermal treatment (as EXAMPLE 1). In comparison with EXAMPLE 4, SMA can't provide satisfied result. The aggregation of the AgNP may be observed by red shift of the peak under

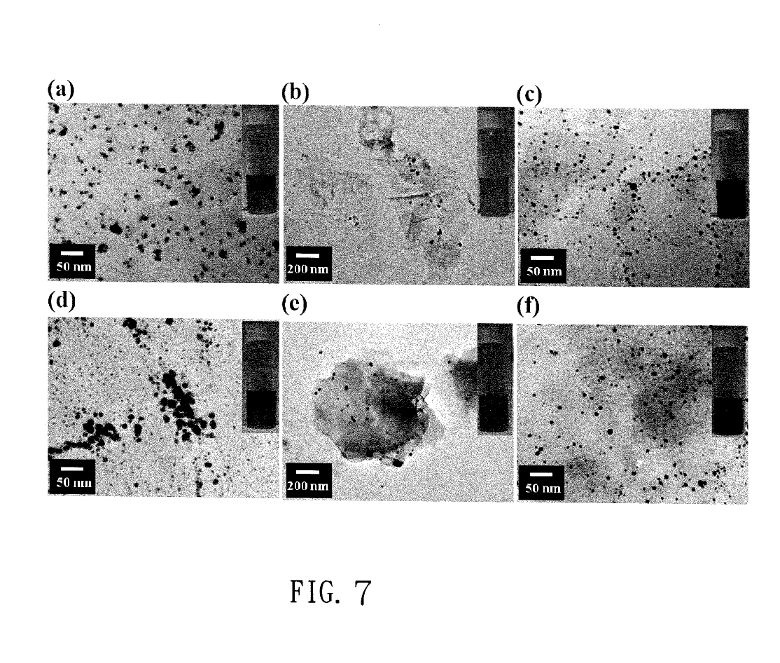

UV-visible spectrometer, as shown in Table 2. FIG. 7 shows the same result.

TABLE 2
absorbance peak's change of the AgNP after exposure under UV
light and thermal treatment

| | | Stabilization of AgNP | | |
|---|---|---|---|---|
| | Wavelength^{a} | dispersing | | |
| | (nm) | agent^{b} | MMT | NSP |
| UV light | 254 | 2 | 0 | 0 |
| | 365 | 2 | 0 | 0 |
| Thermal | 80° C. | 14 | 0 | 0 |
| treatment | | | | |

^{a}Δλₘₐₓ is the maximum change of the wavelength after UV light exposure or thermal treatment;
^{b}SMA3000-M2070

3) The Reversibility of the AgNP after Film-Forming Process:

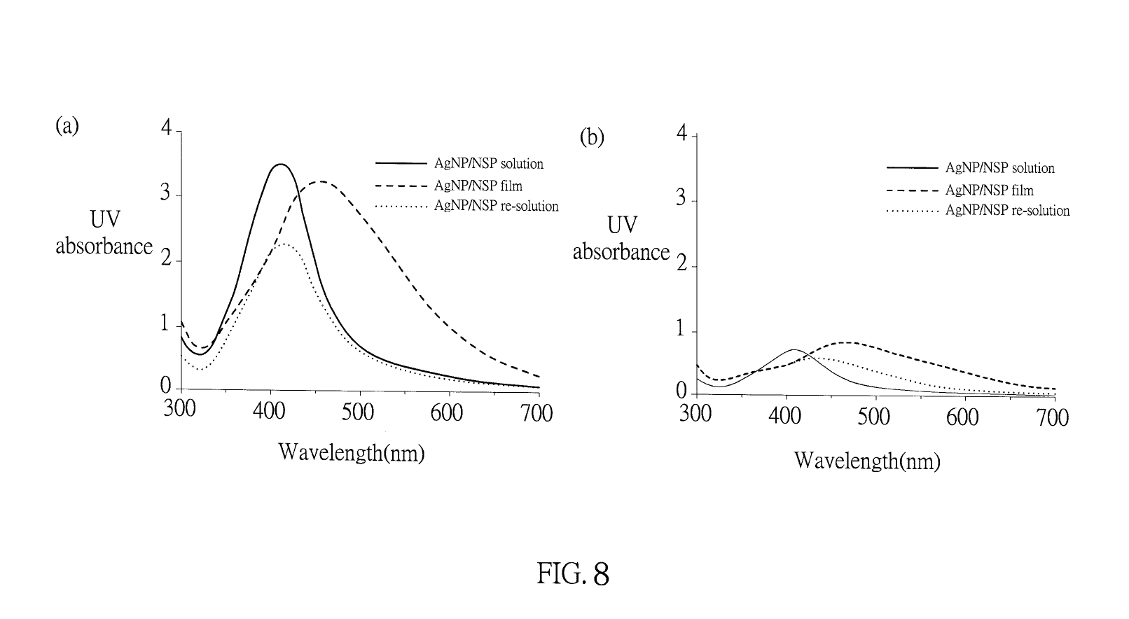

Clay stabilizer is better than SMA, and NSP is even better than normal clay (e.g. MMT). According to EXAMPLE 1 and comparison example 1, during the stabilization test, when AgNP/NSP is re-dissolved in water after film-forming process, it will find that the characteristic absorbance peak of AgNP/NSP returns to the state in the original solution. It indicates the reversibility of the AgNP. However, the reversibility is not found in AgNP/MMT. FIG. 8 shows the result of the UV-visible spectrometer, and the reversibility can be determined through the position of the absorbance peak.

4) Control of the Size of the AgNP:

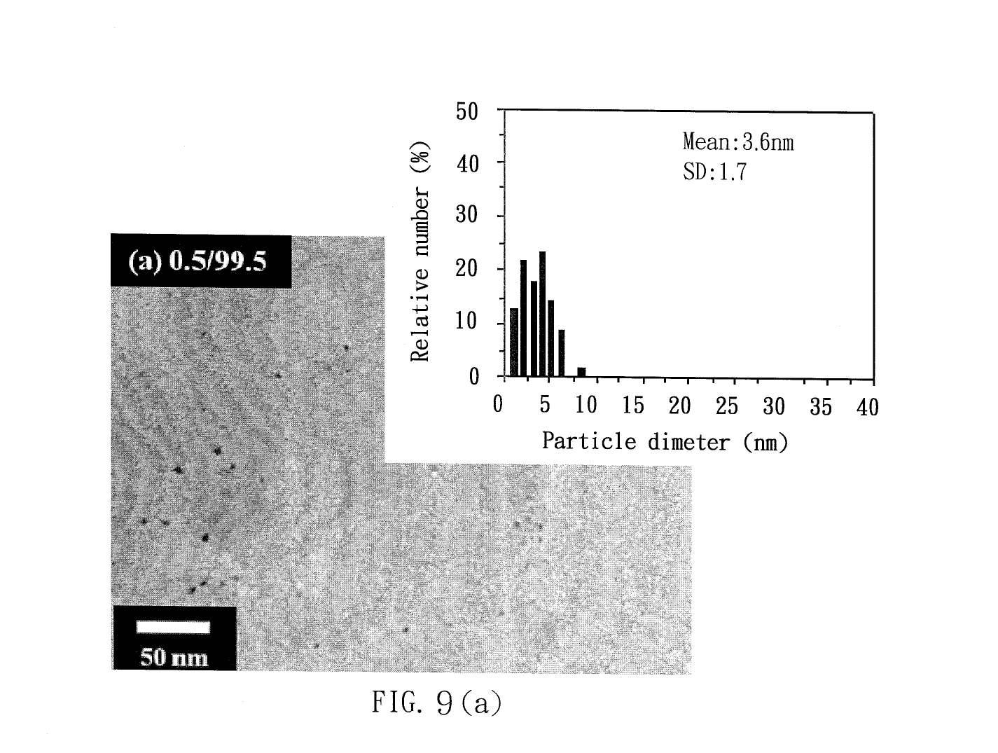

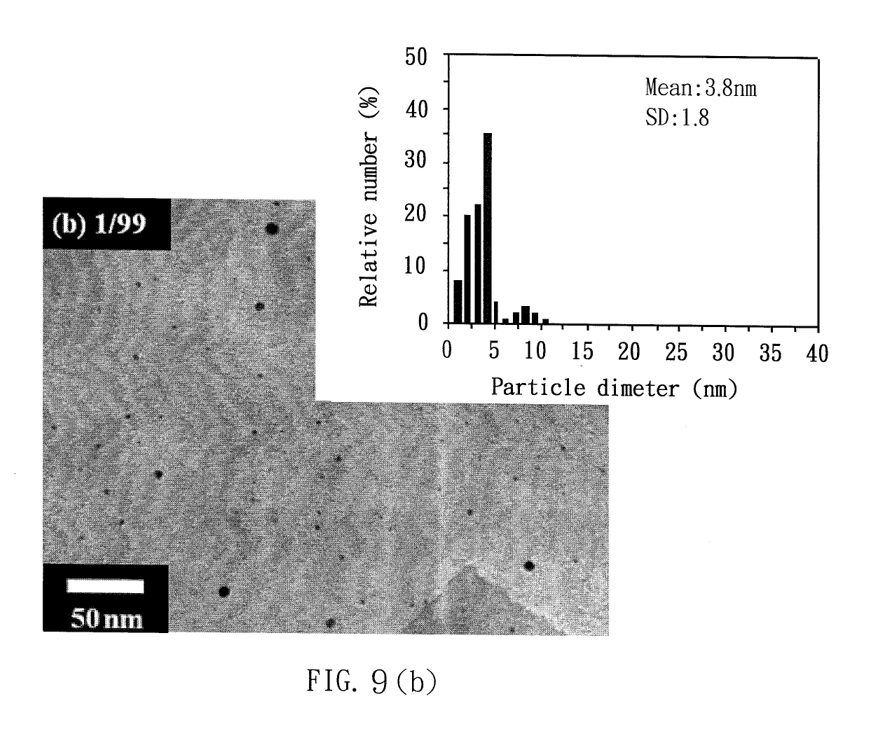

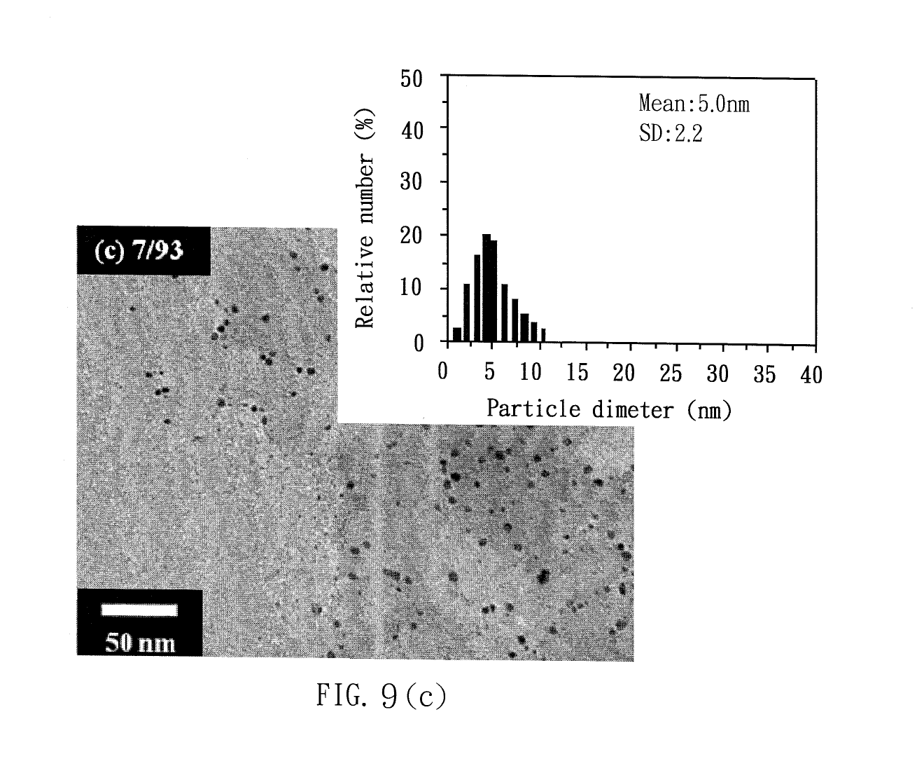

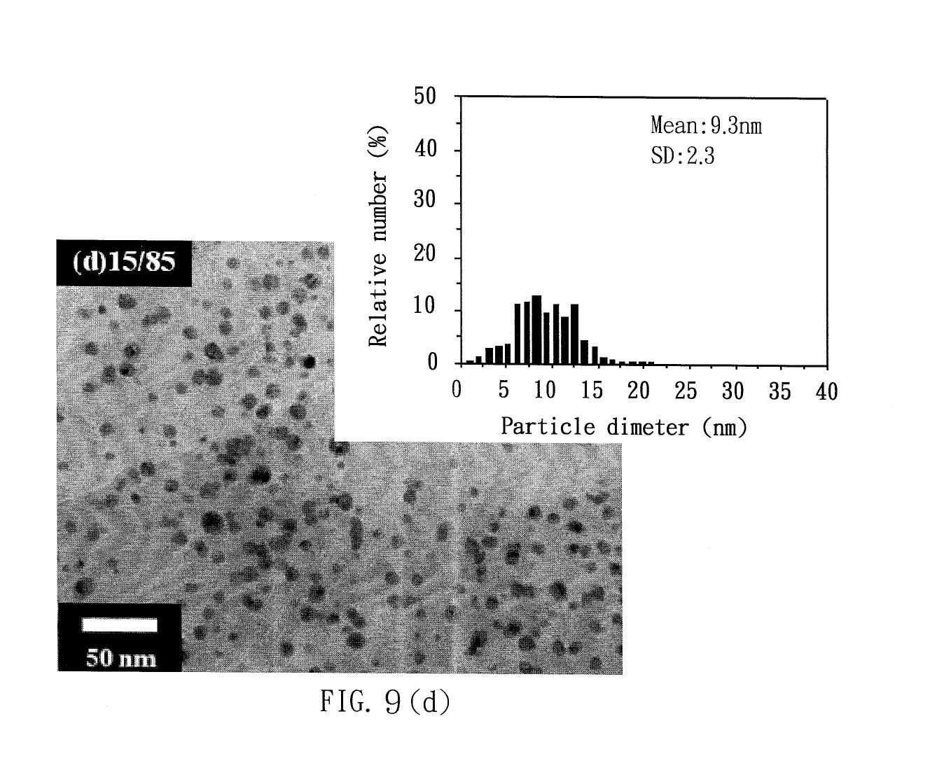

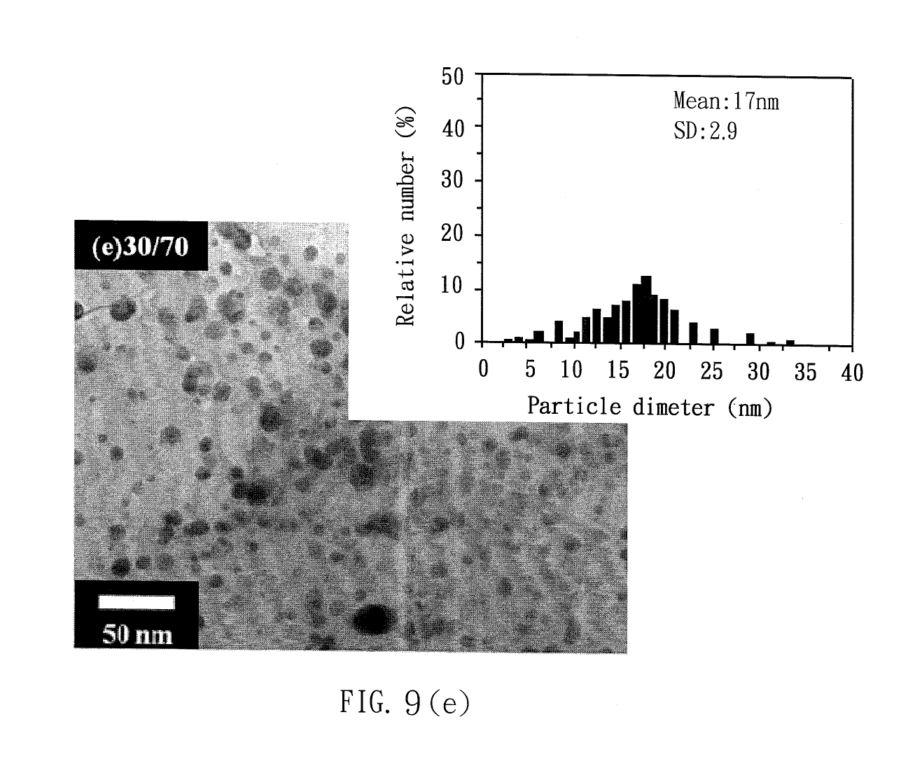

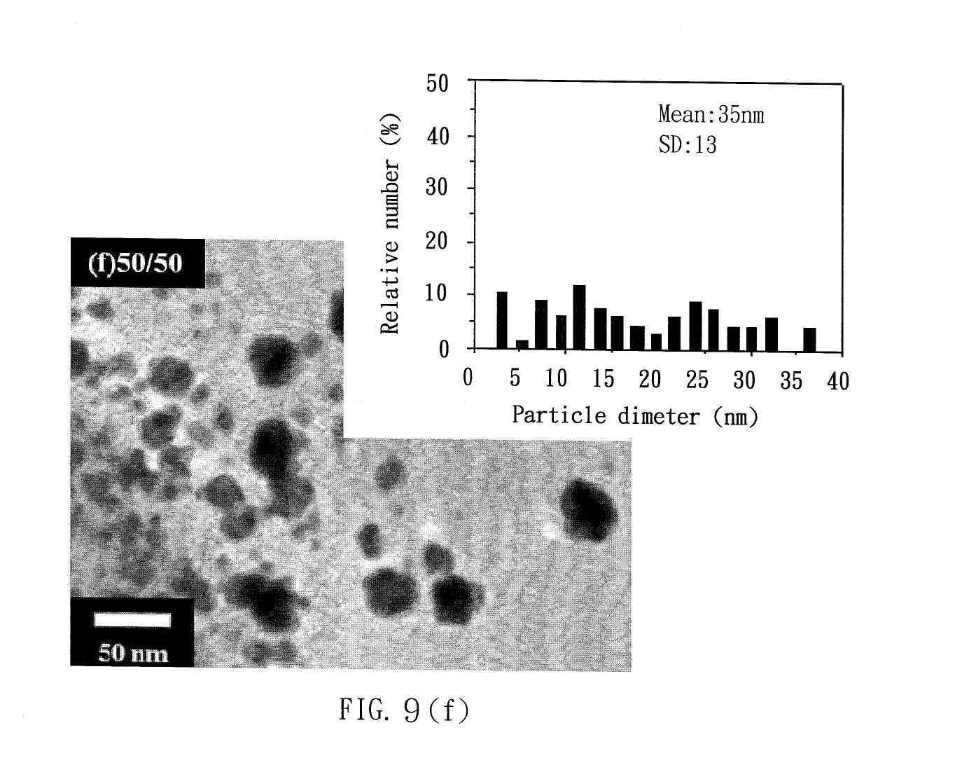

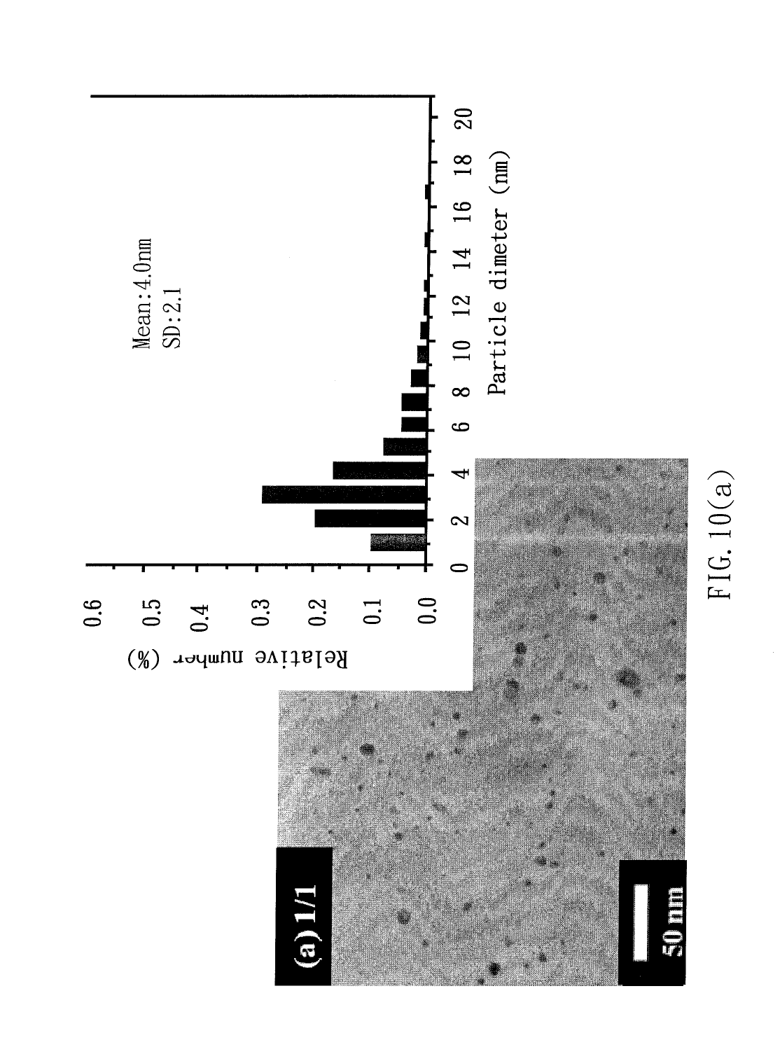

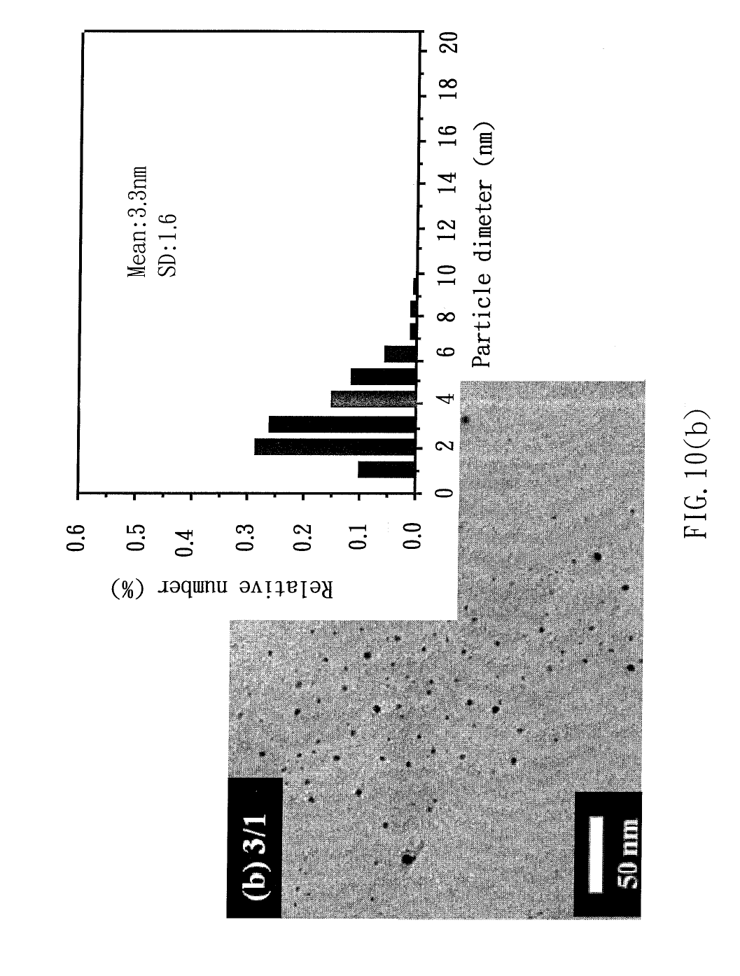

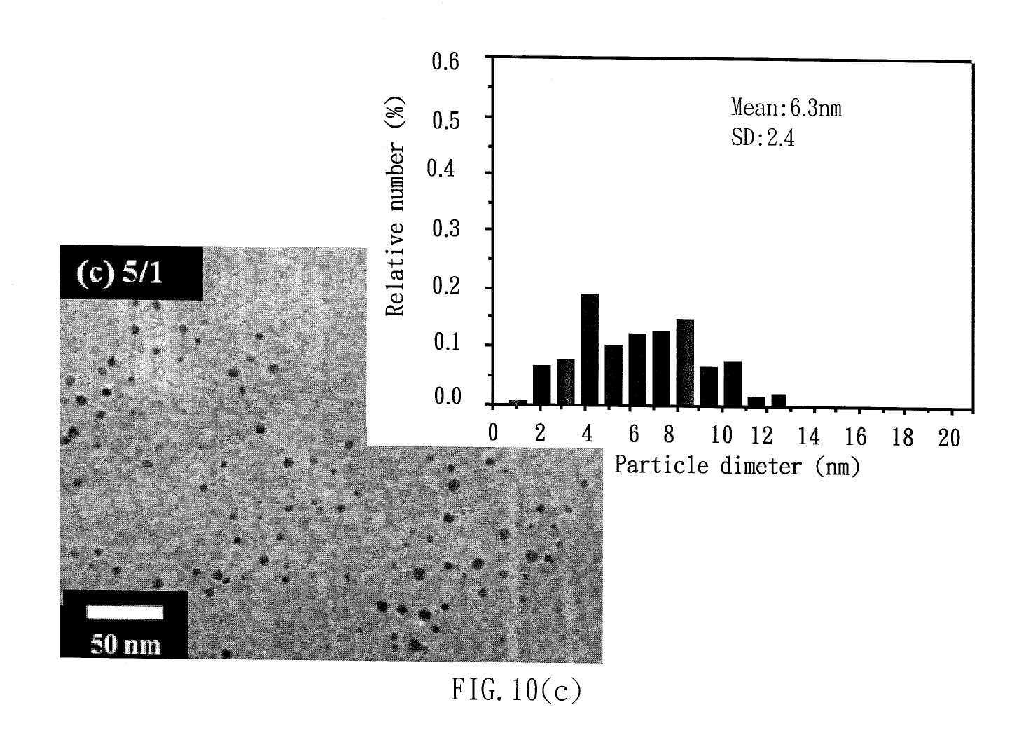

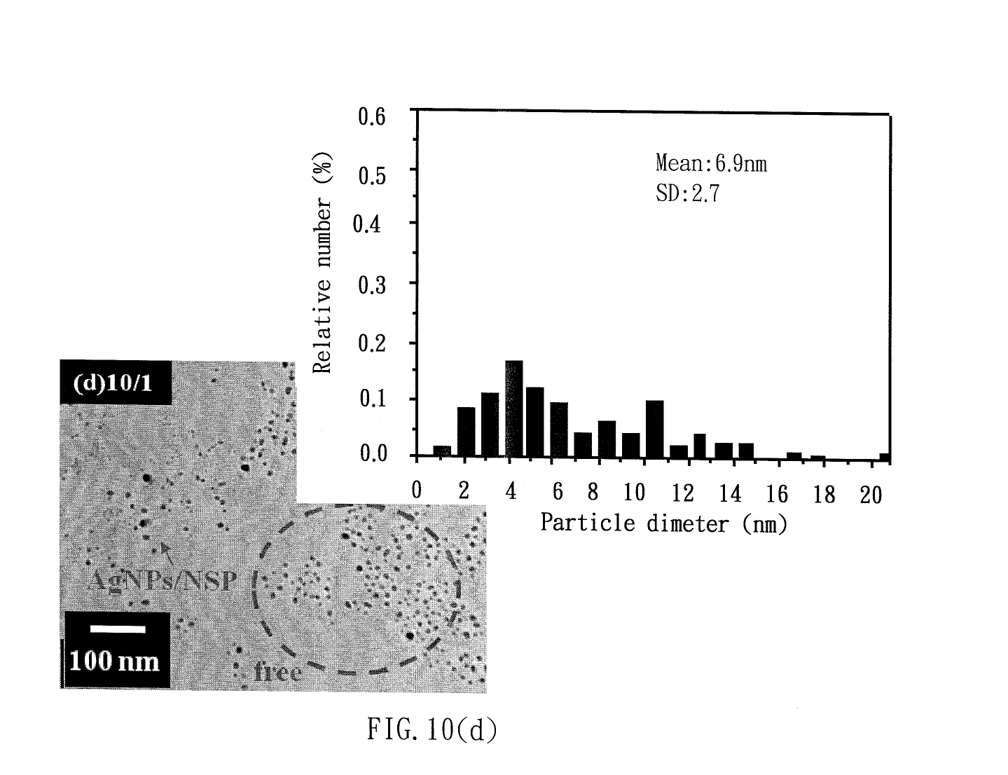

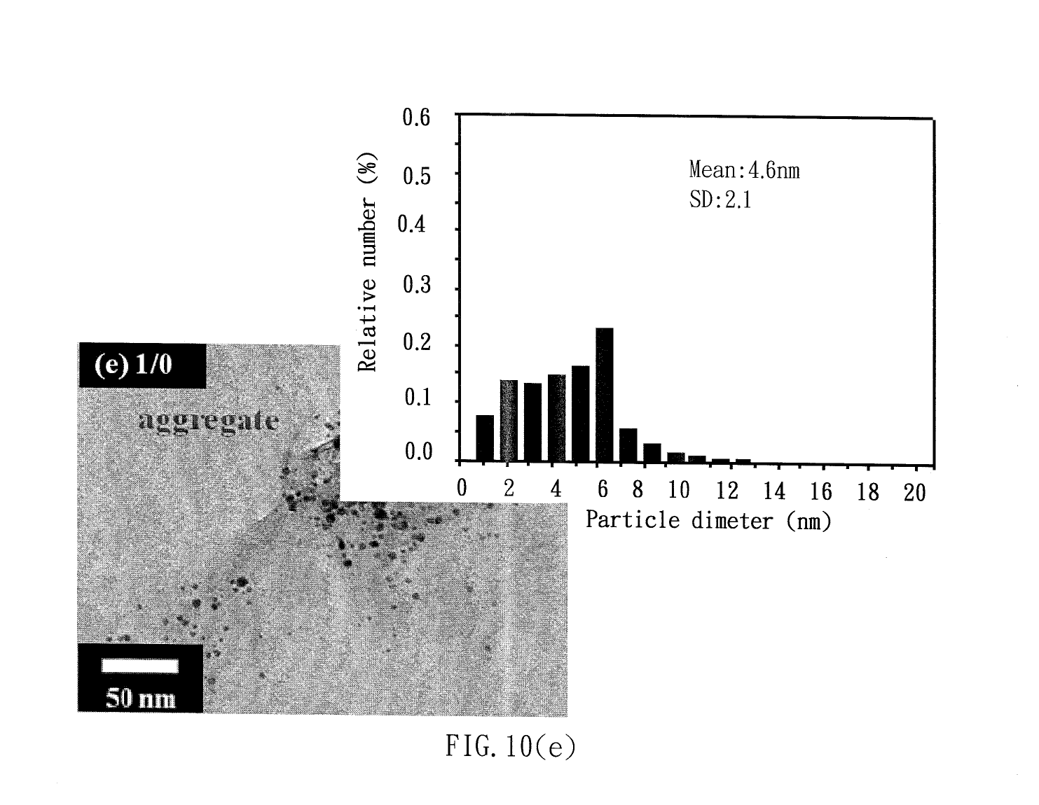

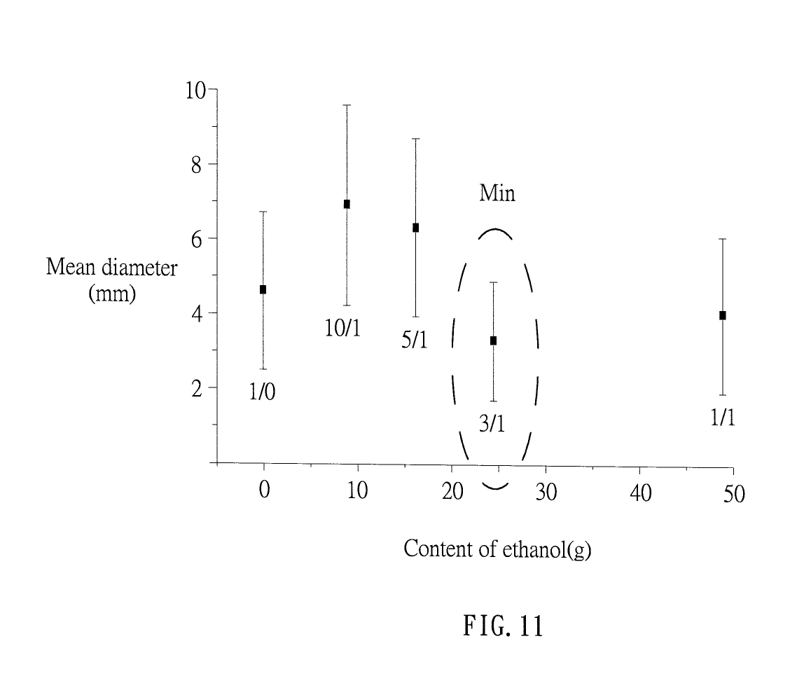

By using the ion attracting force on the surfaces of NSP to disperse the ball-like AgNP which may steadily keep the AgNP on the NSP, different mano-scale silver particles solutions may be obtained through the reactions with different weight ratios of Ag⁺/NSP (as the EXAMPLE 1-6 in Table 1), and the diameters of the silver particles is in a range between 3.6nm and 35nm (FIG. 9(a) to FIG. 9(f)). The reactions under different weight ratios of DI water/ethanol (the EXAMPLE 1, 7-10 in Table 1) may control the diameters of the AgNP. The smallest diameter may be obtained while the ratio of DI water/ethanol is 3/1 (EXAMPLE 7), and the mean diameter is about 3.3nm (FIG. 10(a) to FIG. 10(e) and FIG. 11). Table 3 shows the diameter distribution of the AgNP.

TABLE 3
Diameter of AgNP/dispersing agent and the wavelength obtained
by UV-visible spectrometer

| | Weight | Weight | | | |
|---|---|---|---|---|---|
| | ratio of | ratio of | | | |
| | AgNP/ | DI water/ | | UV | Diameter |
| | dispersing | reducing | Reducing | wavelength | of TEM |
| | agent^{a} | agent | agent | (nm) | (nm) |
| | Ag⁺/NSP | | | | |
| EXP 1 | 7/93 | 1/1 | Ethanol | 408 | 5.0 |
| EXP 2 | 0.5/99.5 | | | 408 | 3.6 |
| EXP 3 | 1/99 | | | 408 | 3.8 |
| EXP 4 | 15/85 | | | 409 | 9.3 |
| EXP 5 | 30/70 | | | 413 | 17.0 |
| EXP 6 | 50/50 | | | 416 | 35.0 |
| EXP 7 | 1/99 | 3/1 | | 406 | 3.3 |
| EXP 8 | 1/99 | 5/1 | | 412 | 6.3 |
| EXP 9 | 1/99 | 10/1 | | 413 | 6.9 |
| EXP 10 | 1/99 | 1/0 | | 414 | 4.6 |
| | Ag⁺/MMT | | | | |
| CEXP 1 | 7/93 | 1/1 | Ethanol | 413 | 5.1 |
| | Ag⁺/NSP | | | | |
| CEXP 2 | 7/93 | 1/1 | Methanol | 420 | 6.3 |
| CEXP 3 | 7/93 | 1/1 | Isopropyl | 420 | 6.6 |
| | | | alcohol | | |
| | Ag⁺/SMA | solvent | | | |
| CEXP 4 | 7/93 | DI water | Sodium | 413 | 6.9 |
| | | | borohydride | | |

5) The Reversibility of the AgNP with Different Diameters:

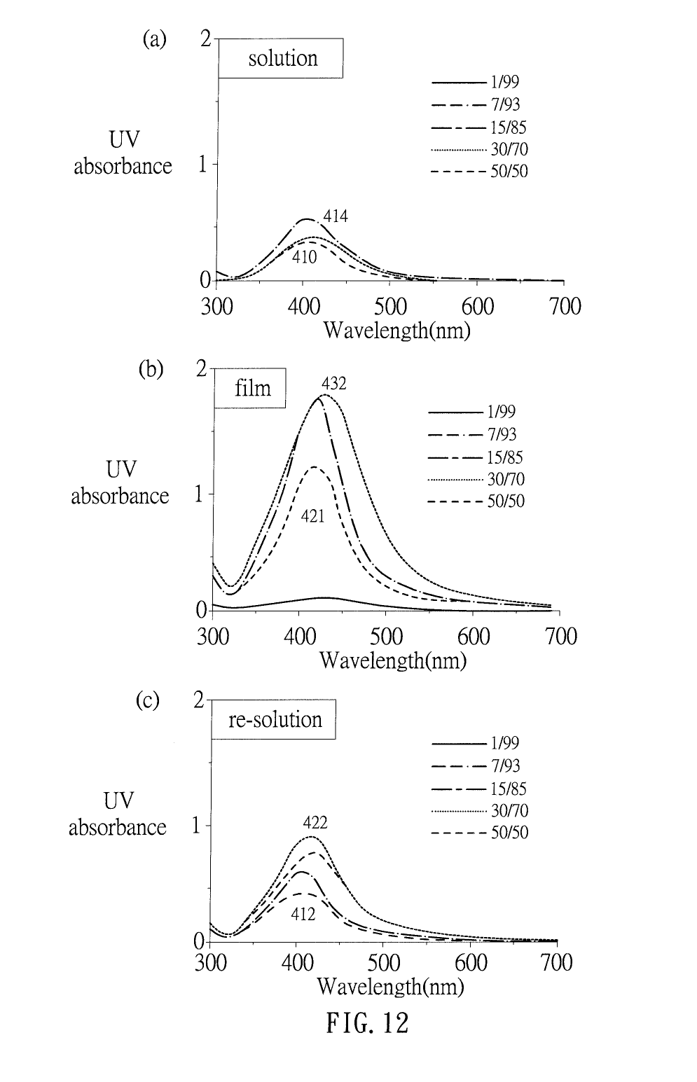

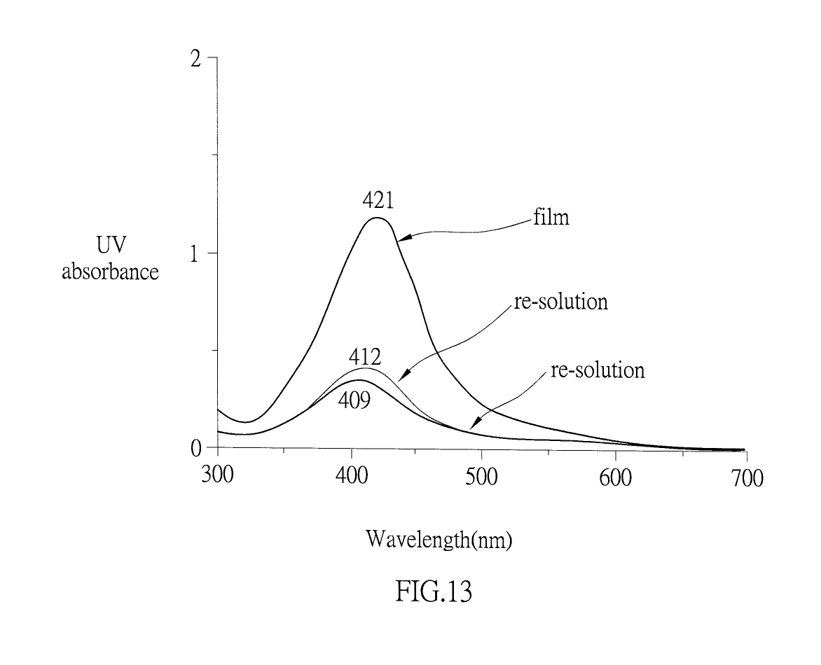

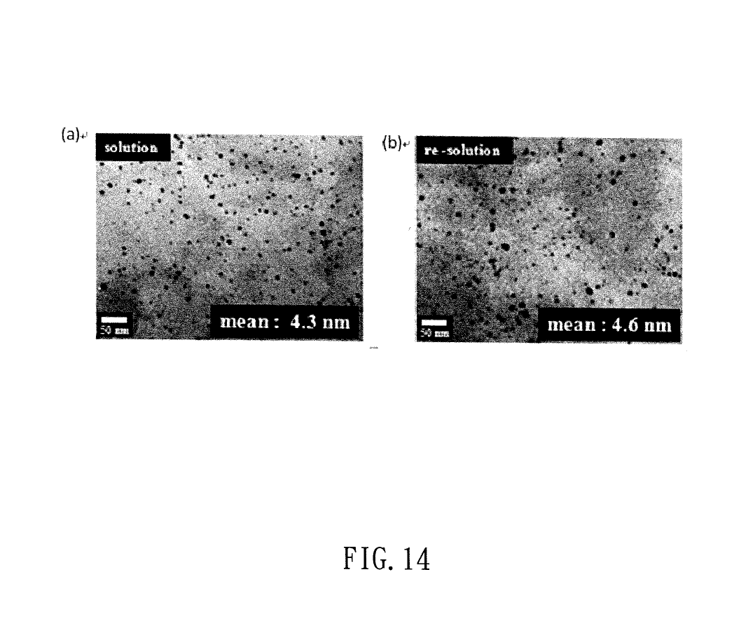

Next, we further tested the reversibility of the AgNP with different diameters and found that the stability of the AgNP is best while the weight ratio of Ag⁺/NSP is in a range between 1/99 and 15/85 (EXAMPLE 1, 3, 4). During the stability test, we found that the characteristic absorbance peak of AgNP/NSP returns to the state in the original solution after re-dissolving the film into water. It is the evidence of the reversibility of the AgNP. The reversibility still works even the AgNPs aggregate while forming the film. The reversibility is poorer while the weight ratio of Ag⁺/NSP is in a range between 30/70 and 50/50 (EXAMPLE 5 and 6), however, it is still better than the AgNP/MMT (comparison example 1). FIG. 12 shows the test result of the UV-visible spectrometer, we can check the reversibility by the position of the absorbance peak. FIG. 13 and FIG. 14 show the UV-visible spectrogram and the test result via the TEM, which shows the size of the AgNP is reversible after the film-forming process, and the particle's size of the AgNP has only slight change before film-forming process and after re-dissolving.

6) The Inhibitory and Bactericidal Ability of the AgNP/Clay:

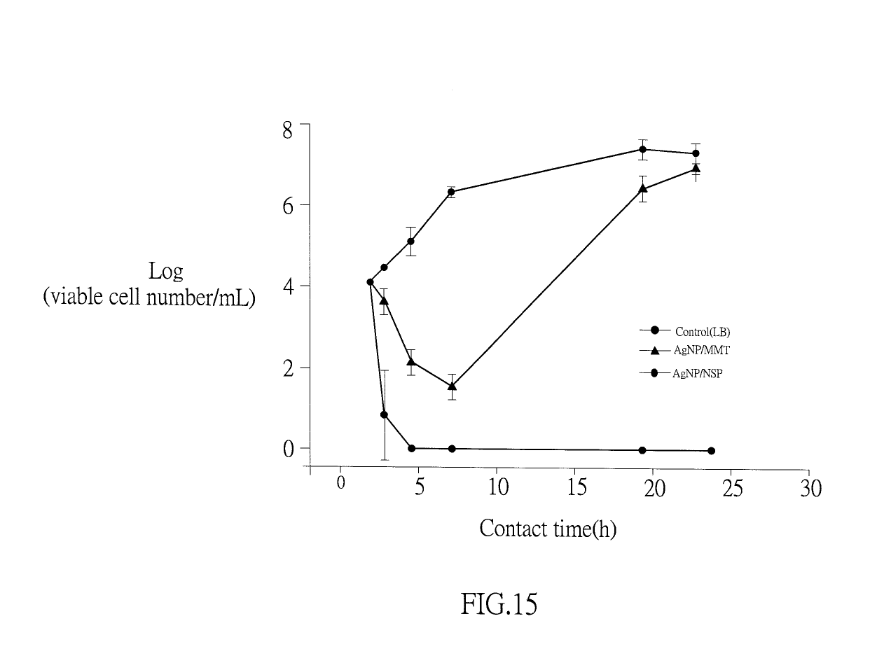

The AgNP/NSP of the present invention has a superior inhibitory ability. FIG. 15 shows the result of the inhibitory test of the AgNP of the comparison example 1, and we found that the AgNP/NSP of EXAMPLE 1 has a superior inhibitory ability. 10 ppm Ag⁺ may kill all the E. coli in three hours of contact. The AgNP/MMT of the comparison example 1 (l0ppm A_{g}+) will lose the inhibitory ability after six hours of contact.

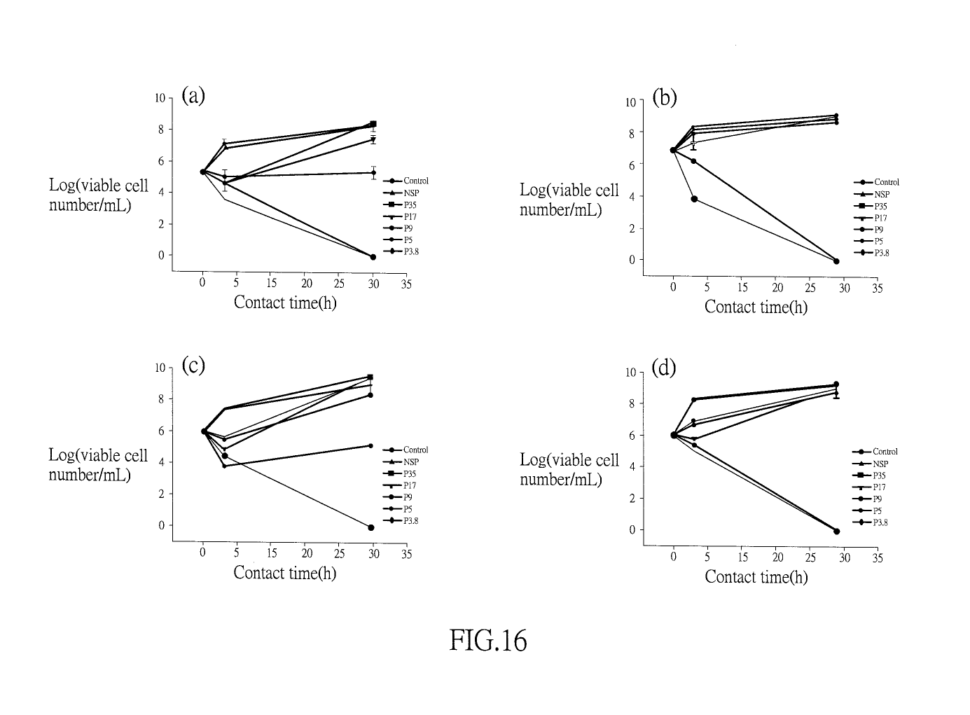

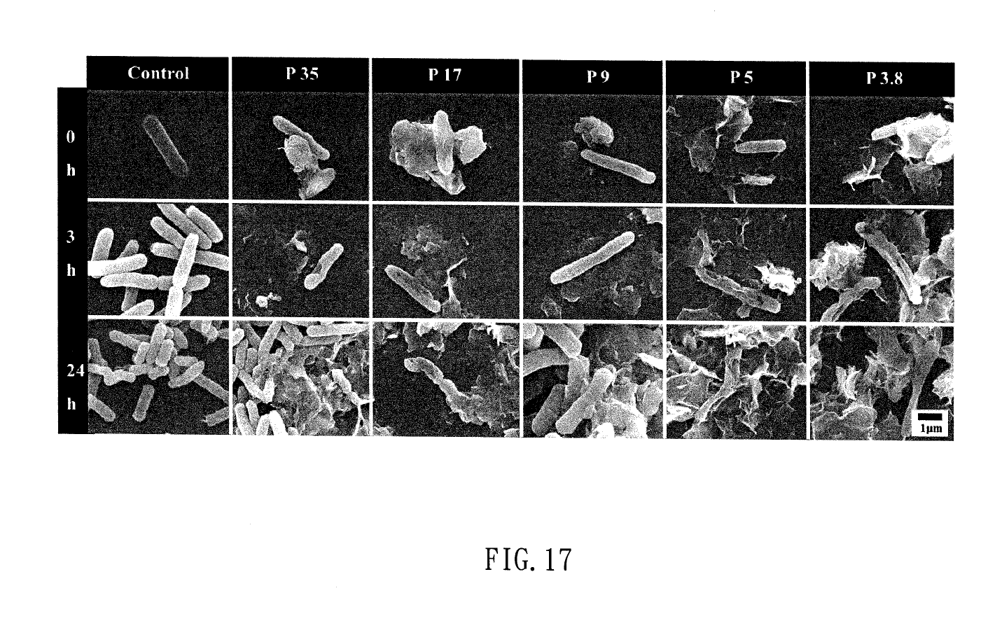

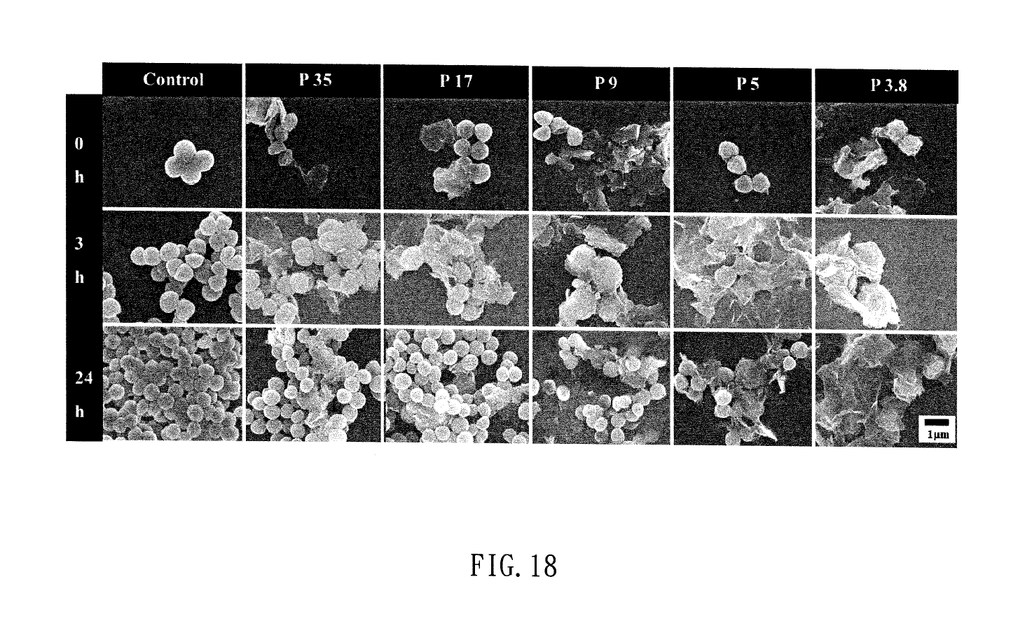

We test the inhibitory ability of the AgNP of EXAMPLE 1, 3-6 with the minimum bactericidal concentration (MBC) of AgNP/NSP (10 ppm). The result shows that the bactericidal ability on the E. coli is better with smaller particles, and the result is the same for the P. aeruginosa, S. aureus, S. pyogenes, and Gram-negative/positive bacteria, as shown in FIG. 16 and Table 4. Therefore, the bactericidal ability is affected by the weight ratio of the AgNP/NSP. It proves that the main fact that affects the bactericidal ability is the particle's size. FIG. 17 and FIG. 18 show the change of strains of E. coli and S. aureus in contact with the AgNP/NSP via the SEM.

TABLE 4
the minimum inhibitory concentration (MIC^{a}) and the minimum
bactericidal concentration (MBC^{b}) of the AgNP/NSP

| bacteria | P 35 | P 17 | P 19 | P 5 | P 3.8 |
|---|---|---|---|---|---|
| | MIC (ug/mL) | | | | |
| E. coli | 14.9 | 14.4 | 19.0 | 3.1 | 1.7 |
| P. aeruginosa | >40 | >40 | 40.0 | 26.3 | 17.2 |
| S. aureus | >30 | 27.5 | 30.7 | 12.7 | 12.4 |
| S. pyogenes | 16.0 | 13.3 | 14.3 | 4.7 | 4.1 |
| | MBC (ug/mL) | | | | |
| E. coli | 18.2 | 19.4 | 25.4 | 7.2 | 4.9 |
| P. aeruginosa | >50 | >50 | 50.0 | 30.1 | 21.5 |
| S. aureus | >30 | 29.1 | 32.0 | 14.9 | 14.7 |
| S. pyogenes | 19.2 | 16.1 | 20.5 | 6.6 | 4.9 |

^{a}the concentration of no visible bacteria colonies growth (after 24 hours, observation with naked eyes)
^{b}the concentration of 99.9% bacteria colonies being killed (24 hours after no bacteria colonies growth being found)

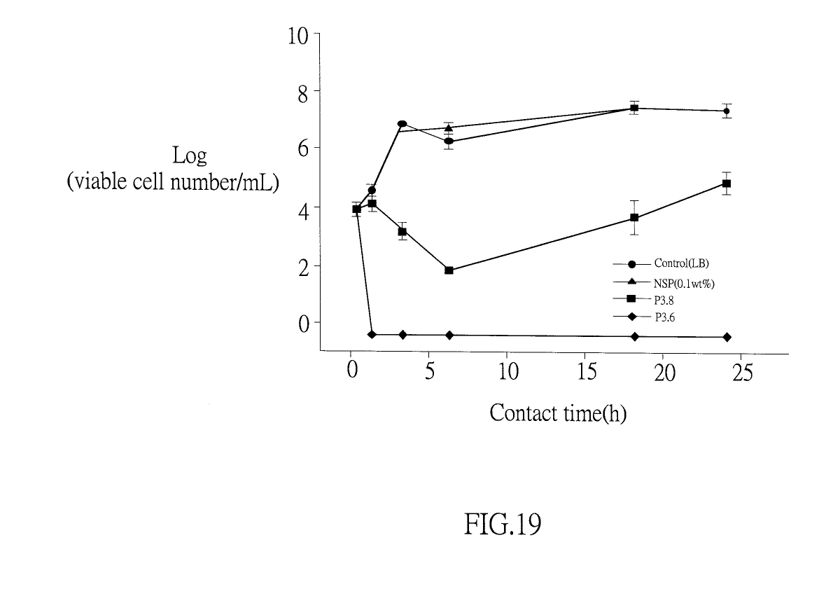

A further bactericidal test is undertaken for comparing the bactericidal ability of AgNP with the same size but in different weight ratios with the NSP (AgNP/NSP is 1/99 and 0.5/99.5 as in EXAMPLE 2 and 3). The result shows that the bactericidal ability of the AgNP/NSP in 0.5/99.5 is better than the AgNP/NSP in 1/99, as shown in FIG. 19. It also proves that the higher ratio of the NSP is, the better bactericidal ability comes. Due to the large surface area and high surface charges of the NSP, the NSP is attached to the bacteria easily, and therefore more AgNP has contact with the bacteria. In other words, the bactericidal ability of the present invention may be controlled by the weight ratio of the AgNP/NSP.

The description above is a few preferred embodiments of the present invention, and the equivalence of the present invention is still in the scope of claim construction of the present invention.

What is claimed is:

1. A method of making a composite of size-controllable metal nanoparticles, comprising the steps of:
a) preparing a solution of exfoliated silicate clay and a solution of metal ions; and
b) mixing the solution of the exfoliated silicate clay with the solution of the metal ions to reduce the metal ions to metal nanoparticles and attach the metal nanoparticles to the exfoliated silicate clay;
wherein further comprise the step of adjusting a weight ratio of the metal ion to the exfoliated silicate clay in the step a), whereby diameters of the metal nanoparticles in the step b) is reducing while the weight ratio of the metal ion to the exfoliated silicate clay in increasing.

2. The method as defined in claim 1, wherein the solution of the exfoliated silicate clay is made by dissolving the exfoliated silicate clay into water.

3. The method as defined in claim 1, wherein the exfoliated silicate clay is made by an exfoliated platelet-shaped clay, and the clay is selected from the group consisting of bentonite, Li-based bentonite, montmorillonite, artificial mica, kaolinite, talc, attapulgite, vermiculite, and smectic hydroxide.

4. The method as defined in claim 1, wherein the exfoliated silicate clay is nanoscale silicate platelets of exfoliated montmorillonite.

5. The method as defined in claim 1, wherein the solution of the exfoliated silicate clay is made by dissolving the exfoliated silicate clay and a reducing agent into water.

6. The method as defined in claim 5, wherein the reducing agent is selected from the group consisting of water, ethanol, methanol, isopropyl alcohol, and sodium borohydride.

7. The method as defined in claim 5, wherein a weight ratio of water to the reducing agent is in a range between 1/1 and 10/1.

8. The method as defined in claim 5, wherein the exfoliated silicate clay is made by an exfoliated platelet-shaped clay, and the clay is selected from the group consisting of bentonite, Li-based bentonite, montmorillonite, artificial mica, kaolinite, talc, attapulgite, vermiculite, and smectic hydroxide.

9. The method as defined in claim 5, wherein the exfoliated silicate clay is nanoscale silicate platelets of exfoliated montmorillonite.

10. The method as defined in claim 1, wherein the metal ion is selected from the group consisting of silver ion, iron ion, copper ion, and gold ion.

11. The method as defined in claim 1, wherein the metal ion is silver ion.

12. The method as defined in claim 1, wherein the solution of metal ion is selected from the group consisting of metal ion nitrate solution, metal ion chloride solution, and metal ion bromated solution.

13. The method as defined in claim 1, wherein the solution of metal ion is selected from the group consisting of silver nitrate solution, silver chloride solution, and silver bromated solution.

14. The method as defined in claim 1, wherein the weight ratio of the metal ion to the exfoliated silicate clay is in a range between 0.5/99.5 and 50/50, and the diameter of the metal nanoparticles is in a range between 3.6nm and 35nm.

15. A composite of size-controllable metal nanoparticles, comprising an exfoliated silicate clay and a plurality of metal particles attached to the exfoliated silicate clay.

16. The composite as defined in claim 15, wherein the exfoliated silicate clay and the metal particles are dissolved in a solvent which is selected from the group consisting of water, ethanol, methanol, isopropyl alcohol, and sodium borohydride.

17. The composite as defined in claim 15, wherein the composite is made into powder.

18. The composite as defined in claim 15, wherein the composite is made into a film.

19. The composite as defined in claim 17, wherein the powder is dissolved in a solvent which is selected from the group consisting of water, ethanol, methanol, isopropyl alcohol, and sodium borohydride.

20. The composite as defined in claim 18, wherein the film is dissolved in a solvent which is selected from the group consisting of water, ethanol, methanol, isopropyl alcohol, and sodium borohydride.
